(19) United States
(12) Patent Application Publication
(10) Pub. No.: US 2026/0028530 A1
(43) Pub. Date: Jan. 29, 2026

(54) LIQUID CRYSTALLINE MEDIUM

(71) Applicant: MERCK PATENT GmbH, Darmstadt (DE)

(72) Inventors: Izumi SAITO, Darmstadt (DE); Elisabeth MEYER, Darmstadt (DE)

(73) Assignee: MERCK PATENT GmbH, Darmstadt (DE)

(21) Appl. No.: 18/994,673

(22) PCT Filed: Jul. 17, 2023
(86) PCT No.: PCT/EP2023/069745

§ 371 Date: Jan. 15, 2025

(30) Foreign Application Priority Data
Jul. 20, 2022 (EP) 22185914

(51) Int. Cl. C09K 19/30; C09K 19/04; C09K 19/12; C09K 19/18; C09K 19/20; C09K 19/34; C09K 19/50

(52) U.S. Cl. CPC C09K 19/3003; C09K 19/12; C09K 19/18; C09K 19/2007; C09K 19/3048; C09K 19/3059; C09K 19/3068; C09K 19/3402; C09K 19/3491; C09K 19/50; C09K 2019/0466; C09K 2019/122; C09K 2019/123; C09K 2019/124; C09K 2019/181; C09K 2019/2042; C09K 2019/3004; C09K 2019/3009; C09K 2019/301; C09K 2019/3016; C09K 2019/3019; C09K 2019/3025; C09K 2019/3054; C09K 2019/3063; C09K 2019/3083; C09K 2019/3422

(57) ABSTRACT

A liquid-crystalline medium having a nematic phase comprising one or more compounds of formula I

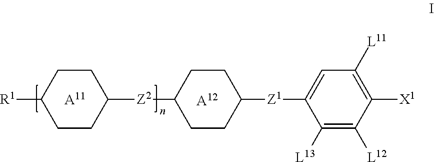

and a negative dielectric component. It can be used in liquid-crystal electrooptical elements, particularly in liquid-crystal lenses. The mixtures have high optical anisotropy and high refractive index, simultaneously they are suitable for fast switching combined with low power consumption using a dual frequency addressing.

The present invention relates to novel liquid crystalline media, in particular for use in liquid-crystal electrooptical elements, and to these elements, particularly to liquid-crystal displays or optical lenses, which use an optimized dual frequency addressing for short response times combined with low power consumption.

Dielectric dispersion is the dependence of the permittivity of a dielectric material on the frequency of an applied electric field. Dual frequency liquid crystal (DFLC) materials or mixtures have a high dispersion in the dielectric anisotropy, i.e. the dielectric anisotropy, Δε(f)=ε_{∥(f)}−ε_{⊥(f)} depends from the frequency, resulting in a change in sign at the crossover frequency f_{co}, where Δε_{(fco)}=0. In some DFLC materials, f_{co} occurs at a few kHz and Δf_{co} changes significantly over the range 1-100 kHz at 20° C. In a DFLC cell, the director can be driven between either homogeneous or homeotropic alignment by applying an electric field across the sample at a frequency either above or below f_{co} since the molecules of the LC have a preferred direction (unit vector) along which they tend to be oriented. When an electric field is applied to the LC, it will exert a torque on the unit vector. Depending on the sign of the anisotropy, i.e. Δε>0 or Δε<0, this torque will turn and align the director respectively parallel or perpendicular to the field direction. Depending on the frequency of the applied field, the director realigns either toward the homeotropic state (perpendicular to the substrates) or toward the planar state (parallel to the substrates). In case of lens applications based on a dual-frequency nematic medium, this allows one to control not only the absolute value of the focal length but also its sign.

The response time of the liquid crystal material is firstly driven by the value of the electric field during switching on. However switching off depends on the relaxation, which can be rather slow. The possible inversion in the sign of the effective dielectric anisoptropy in dual frequency devices allows for actively driving the switching off phase by an electric signal. Thus short switching times can be achieved. This is especially interesting in case of materials with highly optimized optical properties, which are usually hardly compatible with fast responding mixture concepts.

A dual frequency liquid crystalline mixture is usually composed of two categories of materials, compounds exhibiting a positive dielectric anisotropy at low frequencies and compounds exhibiting a negative dielectric anisotropy at high frequencies. Some materials have been disclosed for such mixtures in several publications, like in Haiqing Xianyu, Shin-Tson Wu & Chih-Lung Lin (2009) Dual frequency liquid crystals: a review, Liquid Crystals, 36:6-7, 717-726, DOI: 10.1080/02678290902755598. Jie Sun et al. Liquid Crystals Vol. 36, No. 12, December 2009, 1401-1408 describe polar nitriles and isothiocyanates as components of dual frequency liquid crystals. Guidelines for making dual frequency mixtures are provided in these documents.

The crossover frequency is defined as the frequency at which the dielectric anisotropy changes sign. A lower crossover frequency is usually preferred.

These electrooptic properties of the dual frequency mixtures should ideally be stable with varying temperatures.

IPS and FFS displays using dielectrically positive liquid crystals are well known in the field and have been widely adopted for various types of displays like e.g. desk top monitors and TV sets, but also for mobile applications. However, recently, IPS and in particular FFS displays using dielectrically negative liquid crystals are widely adopted. The latter ones are sometimes also called UB-FFS (ultra bright FFS). Such displays are disclosed e.g. in US 2013/0207038 A1. These displays using conventional, dielectrically negative liquid crystals, however, may have the disadvantage of requiring a higher operation voltage than the respective displays using dielectrically positive liquid crystals.

Liquid crystalline media used for HB-FFS comprising both dielectrically negative and dielectrically positive liquid crystalline compounds, respectively mesogenic compounds are disclosed e.g. in US 2013/0207038 A1.

Industrial application in electro-optical displays and other elements requires LC phases which have to meet a multiplicity of requirements. Particularly important here are chemical resistance to moisture, air and physical influences, such as heat, radiation in the infrared, visible and ultraviolet regions, and direct (DC) and alternating (AC) electric fields.

Furthermore, LC phases which can be used industrially are required to have a liquid-crystalline mesophase in a suitable temperature range and low viscosity.

None of the series of compounds having a liquid-crystalline mesophase that have been disclosed hitherto includes a single compound which meets all these requirements. Mixtures of two to 25, preferably three to 18, compounds are therefore generally prepared in order to obtain substances which can be used as LC phases.

Since in displays in general, i.e. also in displays in accordance with these mentioned effects, the operating voltage should be as low as possible, use is made of liquid-crystal media which are generally predominantly composed of liquid-crystal compounds, all of which have the same sign of the dielectric anisotropy and have the highest possible value of the dielectric anisotropy. In general, at most relatively small proportions of neutral compounds and if possible no compounds having a sign of the dielectric anisotropy which is opposite to that of the medium are employed. In the case of liquid-crystal media having negative dielectric anisotropy e.g. for ECB or UB-FFS displays, predominantly compounds having negative dielectric anisotropy are thus employed. The respective liquid-crystalline media employed generally consist predominantly of liquid-crystal compounds having negative dielectric anisotropy.

However, in the media used in accordance with the present application, significant amounts of dielectrically positive liquid-crystal compounds and amounts of dielectrically negative compounds are typically employed US 2013/0207038 A1 discloses liquid crystalline media for HB-FFS displays proposing to improve the performance of the FFS displays using liquid crystals having a positive dielectric anisotropy by the additional incorporation of dielectrically negative liquid crystals. This, however, leads to the necessity of a compensation of the negative contribution of these compounds to the overall dielectric anisotropy of the resultant media. To this end, either the concentration of the dielectrically positive materials has to be increased, which, in turn, leaves less room for the use of dielectrically neutral compounds as diluters in the mixtures, or, alternatively, compounds with a stronger positive dielectric anisotropy have to be used. Both of these alternatives have the strong drawback of increasing the response time of the liquid crystals in the displays.

The phase range of the liquid-crystal mixture must be sufficiently broad for the intended application of the device. The response times of the liquid-crystal media in the displays should be as low as possible, especially for video, animated simulation and gaming applications. This is particularly important for displays for television or multimedia applications. In order to improve the response times, it has repeatedly been proposed in the past to optimise the rotational viscosity of the liquid-crystal media (γ₁), i.e. to achieve media having the lowest possible rotational viscosity. However, the results achieved here are inadequate for many applications and therefore make it appear desirable to find further optimisation approaches.

Adequate stability of the media to extreme loads, in particular to UV exposure and heating, is very important. In particular in the case of applications in displays in mobile and wearable equipment, such as, for example, mobile telephones and AR/VR headsets, this may be crucial.

Besides their relatively poor transmission and their relatively long response times, the active matrix displays disclosed hitherto, they have further disadvantages. These are e.g. their comparatively low contrast, their relatively high viewing-angle dependence and the difficulty in the reproduction of grey scales in these displays, especially when observed from an oblique viewing angle, as well as their inadequate VHR (voltage holding ratio) and their inadequate lifetime. The desired improvements of the transmission of the displays and of their response times are required in order to improve their energy efficiency, respectively their capacity to render rapidly moving pictures.

There thus continues to be a great demand for active matrix displays having very high specific resistance at the same time as a large working-temperature range, short response times and a relatively low threshold voltage, with the aid of which various grey shades can be produced and which have, in particular, a good and stable VHR.

The invention has the object of providing liquid crystal mixtures for displays or optical lenses, not only for monitor and TV applications, but also for mobile applications such as e.g. telephones, switchable light guides, AR/VR devices, opthalmic glasses, and navigation systems, which are based on the VA, ECB, IPS or FFS effect.

Surprisingly, it has been found that it is possible to achieve liquid-crystal devices which have a low threshold voltage with short response times, a sufficiently broad nematic phase, favourable birefringence (Δn) and, at the same time, a high transmission, high contrast, good stability to decomposition by heating and by UV exposure if use is made in these optical elements of nematic liquid-crystal media according to the invention and the patent claims.

Media of this type can be used, in particular, for electro-optical devices having dual frequency addressing.

The mixtures according to the invention exhibit very broad nematic phase ranges with clearing points ≥70° C., very favourable values for the cross-over frequency, relatively high values for the holding ratio and at the same time good low-temperature stabilities at −20° C. and −30° C. The mixtures according to the invention are furthermore distinguished by a relatively high positive dielectric anisotropy at low frequency.

The liquid crystalline medium of the present invention comprises
a) one or more compounds of formula I, preferably dielectrically positive (1 kHz) compounds, preferably in a concentration in the range from 5% to 50%, more preferably in the range from 10% to 40%, particularly preferably in the range from 15% to 35%,

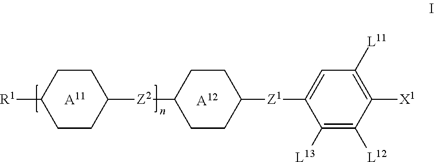

in which
R¹ is an alkyl radical having 1 to 15 C atoms, wherein one or more CH₂ groups, including terminal C atoms, in this radical may each be replaced, independently of one another, by —C≡C—, —CH═CH—,

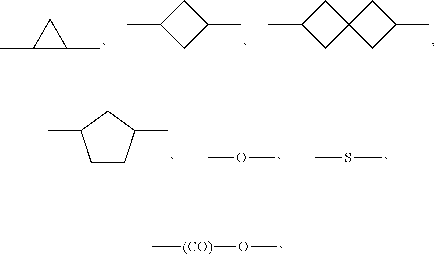

—O—(CO)— in such a way that O or S atoms are not linked directly to one another, and in which, in addition, one or more H atoms may be replaced by F or Cl, or H,

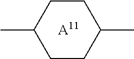

on each appearance, independently of one another, denotes

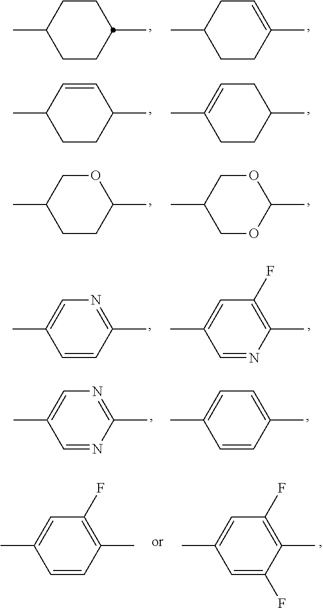

preferably

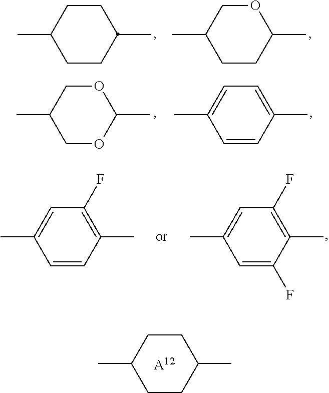

denotes

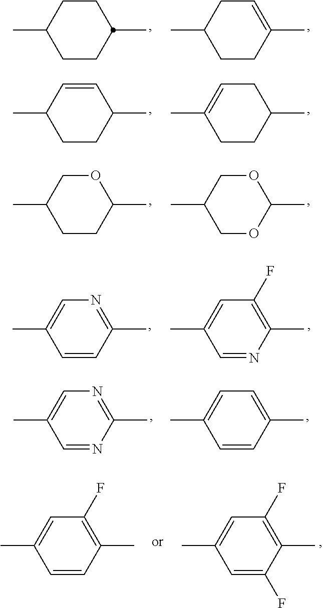

preferably

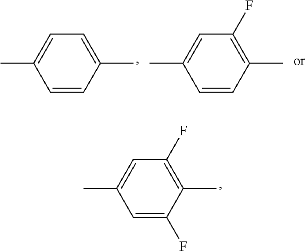

Z¹ denotes —C≡C, —(CO)O— or —CF₂O—, preferably —C≡C—,
Z² denotes a single bond, —(CO)O— or —CF₂O—, preferably a single bond,
L¹¹, L¹², independently H, F or Cl, preferably F,
L¹³ H, CH₃ or CH₂CH₃, preferably H,
X¹—CN, —SCN, —OCF₃ or F, preferably —CN or —SCN,
n denotes 1 or 2, preferably 1,
and
b) one or more compounds, preferably dielectrically negative (1 kHz) compounds, selected from the group of formulae II, III and VI to IX:
   preferably one or more compounds selected from II, III and VII, more preferably selected from II and III,

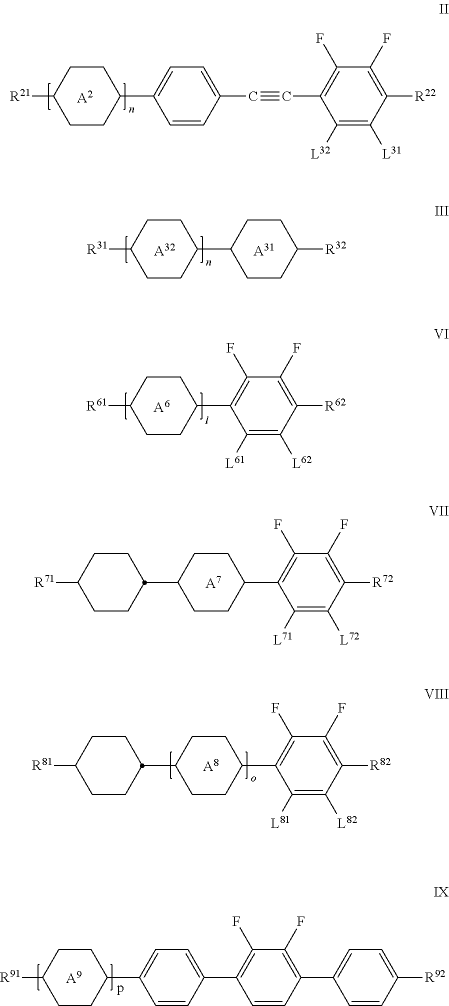

in which
R²¹ and R²² are independently of each other defined as R¹, preferably alkyl or alkoxy with 1 to 7 C-atoms, alkenyl, alkenyloxy or alkoxyalkyl with 2 to 7 C-atoms or C₃₋₅-cycloalkyl-(CH₂)₀₋₁,
preferably
R²¹ is 1 to 7 C alkyl, 2 to 7 C alkenyl, cyclopentyl-(CH₂)— or cyclopentyl, and
R²² is 1 to 7 C alkyl or alkoxy,

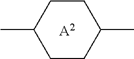

is

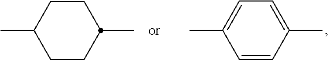

preferably

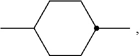

n independently 0 or 1,

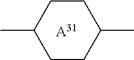

denotes

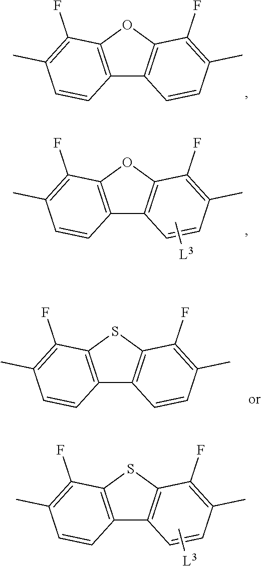

L³ is CH₃, OCH₃ or CH₂CH₃,

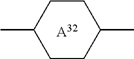

denotes

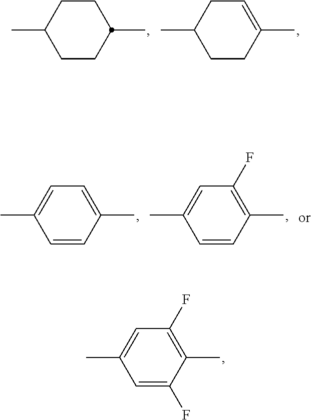

preferably

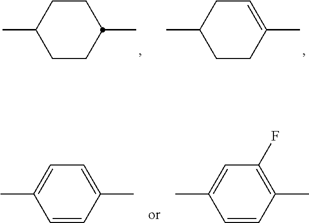

R³¹ and R³² are independently of each other defined as R¹, preferably alkyl or alkoxy with 1 to 7 C-atoms, alkenyl, alkenyloxy or alkoxyalkyl with 2 to 7 C-atoms or C₃₋₅-cycloalkyl-(CH₂)₀₋₁—O—, most preferably 1 to 7 C alkoxy, cyclopentyl-O— or cyclopentyl-CH₂—O—,
   preferably, R³² is alkoxy with 1 to 7 C-atoms,
R⁶¹ is defined independently as R¹, preferably denotes an unsubstituted alkyl radical having 1 to 7 C atoms, preferably a straight-chain alkyl radical, more preferably an n-alkyl radical, most preferably propyl or pentyl, an unsubstituted alkenyl radical having 2 to 7 C atoms, preferably a straight-chain alkenyl radical, particularly preferably having 2 to 5 C atoms, an unsubstituted alkoxy radical having 1 to 6 C atoms, an unsubstituted alkenyloxy radical having 2 to 6 C atoms or C₃₋₅-cycloalkyl-(CH₂)₀₋₁,
R⁶² is defined independently as R¹, preferably denotes an unsubstituted alkyl radical having 1 to 7 C atoms, an unsubstituted alkoxy radical having 1 to 6 C atoms, C₃₋₅-cycloalkyloxy, C₃₋₅-cycloalkylmethoxy or an unsubstituted alkenyloxy radical having 2 to 6 C atoms, and
L⁶¹, L⁶² independently H or methyl, preferably H,
I denotes 0 or 1,
R⁷¹ is defined independently as R¹, preferably denotes an unsubstituted alkyl radical having 1 to 7 C atoms, preferably a straight-chain alkyl radical, more preferably an n-alkyl radical, most preferably propyl or pentyl, an unsubstituted alkenyl radical having 2 to 7 C atoms, preferably a straight-chain alkenyl radical, particularly preferably having 2 to 5 C atoms or C₃₋₅-cycloalkyl-(CH₂)₀₋₁,
R⁷² is defined independently as R¹, preferably denotes an unsubstituted alkyl radical having 1 to 7 C atoms, preferably having 2 to 5 C atoms, an unsubstituted alkoxy radical having 1 to 6 C atoms, preferably having 1, 2, 3 or 4 C atoms, or an unsubstituted alkenyloxy radical having 2 to 6 C atoms, preferably having 2, 3 or 4 C atoms, and
L⁷¹, L⁷² independently is H or methyl, preferably H,

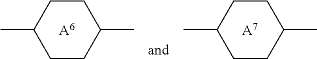

independently denote

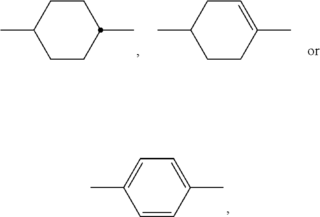

R⁸¹ is defined as R¹, preferably denotes an unsubstituted alkyl radical having 1 to 7 C atoms, preferably a straight-chain alkyl radical, more preferably an n-alkyl radical, most preferably propyl or pentyl, an unsubstituted alkenyl radical having 2 to 7 C atoms, preferably a straight-chain alkenyl radical, particularly preferably having 2 to 5 C atoms or C₃₋₅-cycloalkyl-(CH₂)₀₋₁,
R⁸² is defined as R¹, preferably denotes an unsubstituted alkyl radical having 1 to 7 C atoms, preferably having 2 to 5 C atoms, an unsubstituted alkoxy radical having 1 to 6 C atoms, preferably having 1, 2, 3 or 4 C atoms, an unsubstituted alkenyloxy radical having 2 to 6 C atoms, preferably having 2, 3 or 4 C atoms, or C₃₋₅-cycloalkyloxy,
L⁸¹, L⁸² independently H or methyl, preferably H,

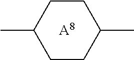

denotes

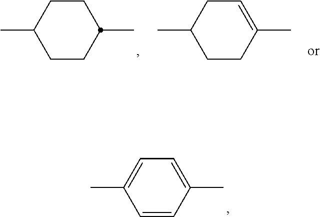

preferably

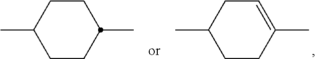

more preferably

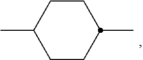

Z⁸ denotes —(CO)—O—, —CH₂—O—, —CF₂—O— or —CH₂—CH₂—, preferably —(CO)—O— or —CH₂—O—, and
o denotes 0 or 1,
R⁹¹ and R⁹² independently of one another have the meaning given for R⁷² above,
R⁹¹ preferably denotes an alkyl radical having 2 to 5 C atoms, preferably having 3 to 5 C atoms,
R⁹² preferably denotes an alkyl or alkoxy radical having 2 to 5 C atoms, more preferably an alkoxy radical having 2 to 4 C atoms, or an alkenyloxy radical having 2 to 4 C atoms.

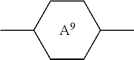

denotes

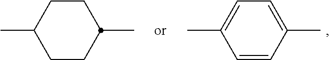

and
p 0 or 1.

The media according to the invention comprise one or more additional compounds, preferably selected from the groups of compounds according to the following conditions c) to f):
c) optionally one or more dielectrically neutral compounds selected from the group of formulae IV and V:

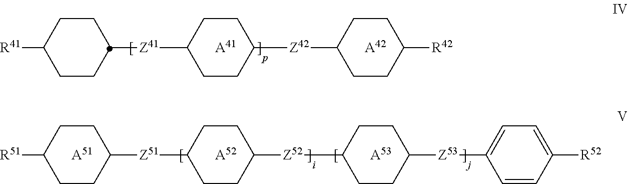

in which
R⁴¹ and R⁴², independently of one another, have the meaning indicated above for R¹ under formula I, preferably R⁴¹ denotes alkyl and R⁴² denotes alkyl, cyclopropyl, cyclopentyl or alkoxy or R⁴¹ denotes alkenyl and R⁴² denotes alkyl,

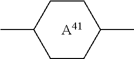

and
   independently of one another and, if

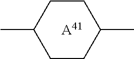

occurs twice,
also these independently of one another, denote

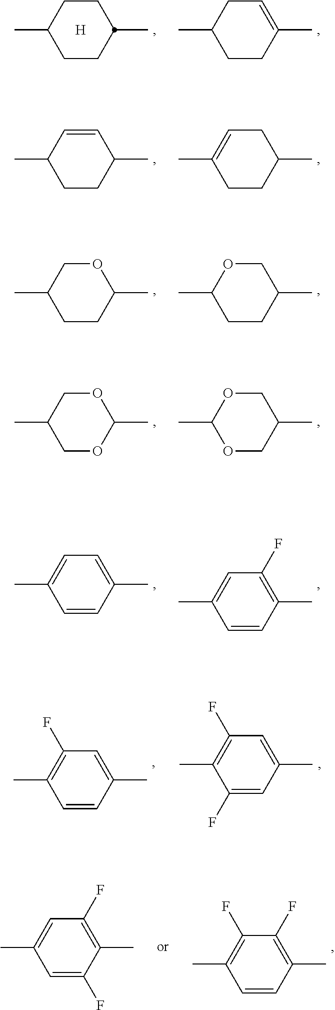

preferably one or more of

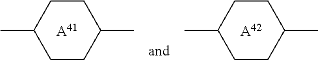

denotes or denote,

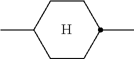

Z⁴¹ and Z⁴², independently of one another and, if Z⁴¹ occurs twice, also these independently of one another,
   denote —CH₂CH₂—, —COO—, trans-CH═CH—, trans-CF═CF—, —CH₂O—, —CF₂O—, —C≡C— or a single bond, preferably one or more thereof denotes/denote a single bond,
p denotes 0, 1 or 2, preferably 0 or 1, and
R⁵¹ and R⁵², independently of one another, have one of the meanings indicated above for R¹ under formula I and preferably denote alkyl having 1 to 7 C atoms, preferably n-alkyl, particularly preferably n-alkyl having 1 to 5 C atoms, alkoxy having 1 to 7 C atoms, preferably n-alkoxy, particularly preferably n-alkoxy having 2 to 5 C atoms, alkoxyalkyl, alkenyl or alkenyloxy having 2 to 7 C atoms, preferably having 2 to 4 C atoms, preferably alkenyloxy,

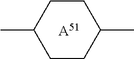

to

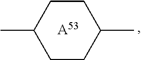

if present, each, independently of one another, denote

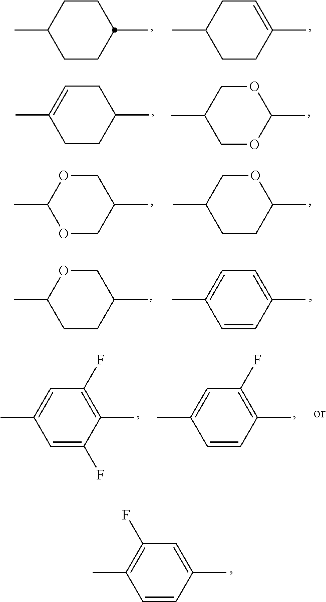

preferably

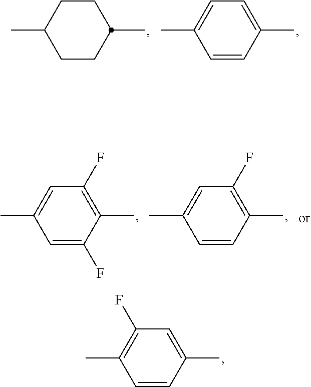

Z⁵¹ to Z⁵³ each, independently of one another, denote —CH₂—CH₂—, —CH₂—O—, —CH═CH—, —C≡C—, —(CO)—O— or a single bond, preferably —C≡C—, —CH₂—CH₂—, —CH₂—O— or a single bond and particularly preferably a single bond or —C≡C—,
i and j each, independently of one another, denote 0 or 1,
(i+j) preferably denotes 0, 1 or 2, more preferably 0 or 1,
wherein the respective rings, and preferably the phenylene rings, optionally may each be substituted by one or two alkyl groups, preferably by methyl and/or ethyl groups, preferably by one methyl group, and
d) again optionally, either alternatively or additionally, preferably dielectrically positive, compounds selected from the group of compounds of formulae XII and XIII, wherein compounds of formula I are excluded, preferably of compounds having a dielectric anisotropy of greater than 3 each, preferably one or more compounds of formula XII:

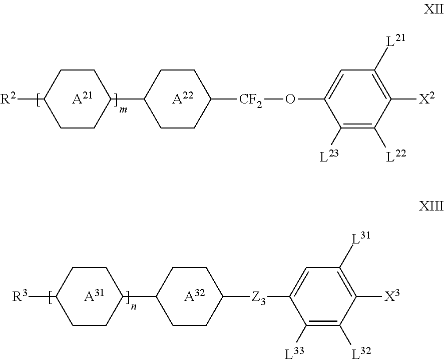

in which
R² an alkyl radical having 1 to 15 C atoms, wherein one or more CH₂ groups, including terminal C atoms, in this radical may each be replaced, independently of one another, by —C≡C—, —CH═CH—,

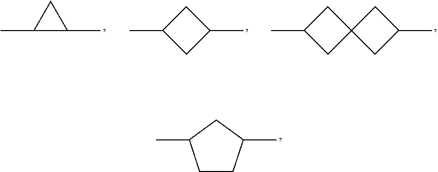

—O—, —S—, —(CO)—O—, —O—(CO)— in such a way that O or S atoms are not linked directly to one another, and in which, in addition, one or more H atoms may be replaced by F or Cl, or H,
   preferably denotes alkyl, alkoxy, fluorinated alkyl or fluorinated alkoxy having 1 to 7 C atoms, alkenyl, alkenyloxy, alkoxyalkyl, fluorinated alkenyl having 2 to 7 C atoms, cycloalkyl with 3 to 5 C atoms, cyclalkylalkyl, cycloalkylalkoxy and most preferably alkyl, cyclopropyl, cyclopentyl or alkenyl,

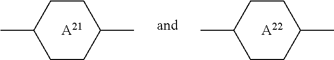

on each appearance, independently of one another, denote

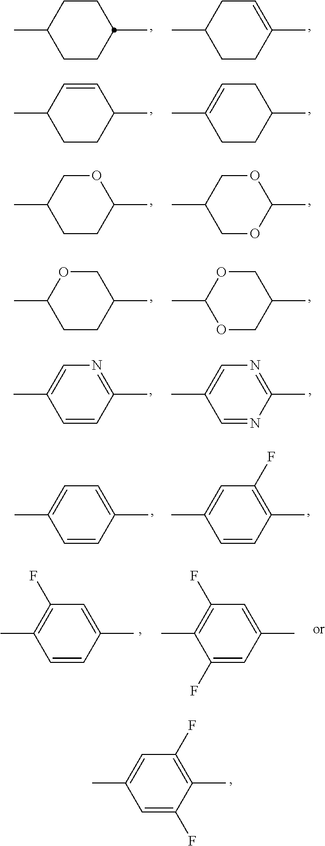

preferably

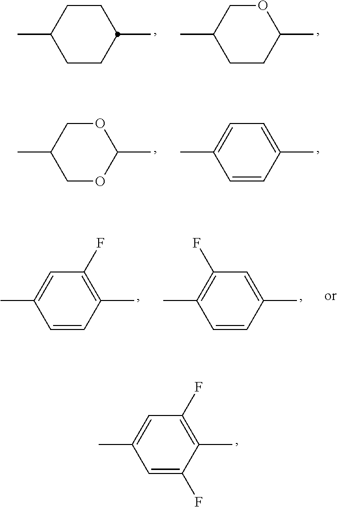

L²¹ and L²² denote H or F,
L²³ H or CH₃, preferably H,
X² denotes halogen, halogenated alkyl having 1 to 3 C atoms or halogenated alkenyl having 2 or 3 C atoms, preferably F, Cl or —CF₃, very preferably F or —CF₃,
m denotes 0, 1 or 2, preferably 1 or 2 and particularly preferably 2,
R³ an alkyl radical having 1 to 15 C atoms, wherein one or more CH₂ groups, including terminal C atoms, in this radical may each be replaced, independently of one another, by —C≡C—, —CH═CH—,

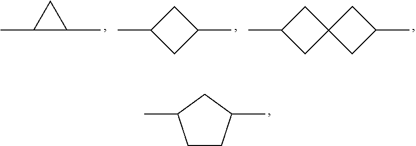

—O—, —S—, —(CO)—O—, —O—(CO)— in such a way that O or S atoms are not linked directly to one another, and in which, in addition, one or more H atoms may be replaced by F or CI, or H,
   preferably denotes alkyl, alkoxy, fluorinated alkyl or fluorinated alkoxy having 1 to 7 C atoms, alkenyl, alkenyloxy, alkoxyalkyl, fluorinated alkenyl having 2 to 7 C atoms, cycloalkyl with 3 to 5 C atoms, cyclalkylalkyl, cycloalkylalkoxy and most preferably alkyl, cyclopropyl, cyclopentyl or alkenyl,

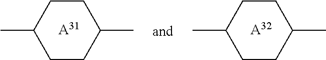

on each appearance, independently of one another, are

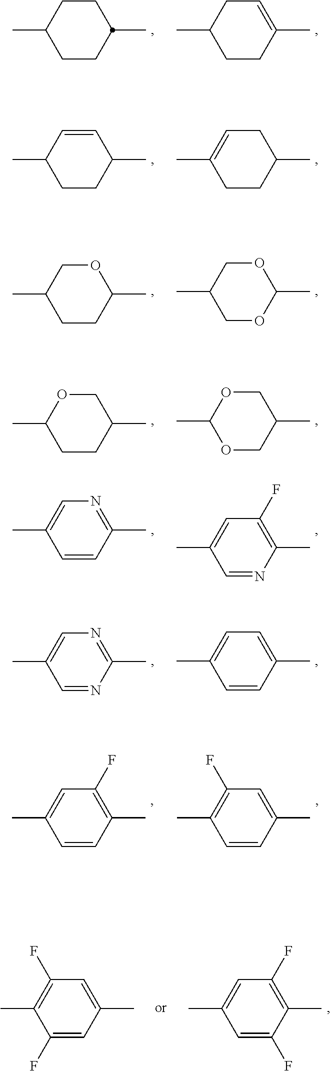

preferably

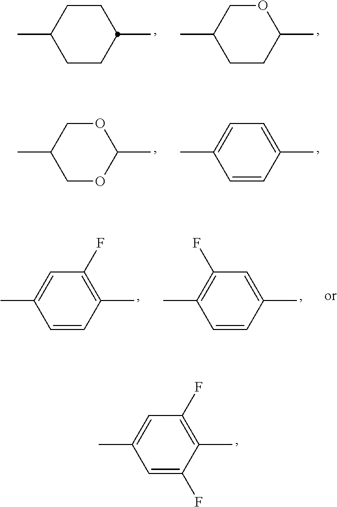

L³¹ and L³², independently of one another, denote H or F, preferably L³¹ denotes F,
L³³ H or CH₃, preferably H,
X³ denotes halogen, halogenated alkyl or alkoxy having 1 to 3 C atoms or halogenated alkenyl or alkenyloxy having 2 or 3 C atoms, F, Cl, —OCF₃, —OCHF₂, —O—CH₂CF₃, —O—CH═CF₂, —O—CH═CH₂ or —CF₃, very
   preferably F, Cl, —O—CH═CF₂, —OCHF₂ or —OCF₃,
Z³ denotes —CH₂CH₂—, —CF₂CF₂—, trans-CH═CH—, trans-CF═CF—, —CH₂O— or a single bond,
   preferably —CH₂CH₂—, trans-CH═CH— or a single bond and very preferably trans-CH═CH— or a single bond, and
n denotes 0, 1, 2 or 3, preferably 1, 2 or 3 and particularly preferably 1.

The liquid-crystalline media in accordance with the present application preferably have a nematic phase.

Further objects of the present invention are an optical lens or electrooptical devices and displays, which use the liquid crystalline media of the current invention. Particularly useful are optical devices comprising one or more electro-optical lenses based on the invention, which have means to operate the lens by dual frequency addressing. Use is made of an LC medium according to the invention in an electro-optical component having a a dual frequency addressing.

Throughout this application and especially for the definition of R¹, R², R²¹, R²², R³, R³¹, R^{41/42}, R^{51/52} etc. alkyl means an alkyl group, which may be straight-chain or branched. Each of these radicals is preferably straight-chain and preferably has 1, 2, 3, 4, 5, 6, 7 or 8 C atoms and is accordingly preferably methyl, ethyl, n-propyl, n-butyl, n-pentyl, n-hexyl or n-heptyl.

In case alkyl means a branched alkyl group it preferably means 2-alkyl, 2-methylalkyl or 2-(2-ethyl)-alkyl, preferably 2-butyl (=1-methylpropyl), 2-methylbutyl, 2-methylpentyl, 3-methylpentyl, 2-ethylhexyl, 2-propylpentyl, in particular 2-methylbutyl, 2-methylbutoxy 4-methylhexyl, 2-hexyl, 2-octyl, 2-nonyl, 2-decyl and 2-dodecyl. Most preferred of these groups are 2-hexyl and 2-octyl.

Respective branched groups which lead to chiral compounds are also called chiral groups in this application. Particularly preferred chiral groups are 2-alkyl, 2-alkoxy, 2-methylalkyl, 2-methylalkoxy, 2-fluoroalkyl, 2-fluoroalkoxy, 2-(2-ethin)-alkyl, 2-(2-ethin)-alkoxy, 1,1,1-trifluoro-2-alkyl and 1,1,1-trifluoro-2-alkoxy.

Particularly preferred chiral groups are 2-butyl (=1-methylpropyl), 2-methylbutyl, 2-methylpentyl, 3-methylpentyl, 2-ethylhexyl, 2-propylpentyl, in particular 2-methylbutyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa-4-methylpentyl, 4-methylhexyl, 2-hexyl, 2-octyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleroyloxy, 4-methylhexanoyloxy, 2-chlorpropionyloxy, 2-chloro-3-methylbutyryloxy, 2-chloro-4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy, 2-fluorodecyloxy, 1,1,1-trifluoro-2-octyloxy, 1,1,1-trifluoro-2-octyl, 2-fluoromethyloctyloxy for example. Very preferred are 2-hexyl, 2-octyl, 2-octyloxy, 1,1,1-trifluoro-2-hexyl, 1,1,1-trifluoro-2-octyl and 1,1,1-trifluoro-2-octyloxy.

Throughout this application alkenyl means an alkenyl group, which may be straight-chain or branched and preferably is straight chain and preferably has 2, 3, 4, 5, 6 or 7 or 8 C atoms. Preferably it is vinyl, 1-E-alkenyl or 3-E-alkenyl, most preferably it is vinyl, 1-E-propenyl, 1-E-butenyl, 1-E-pentenyl, 3-butenyl oder 3-E-pentenyl.

Groups defined as C₃₋₅-cycloalkyl-(CH₂)₀₋₁ refer to cyclopentyl, cyclobutyl or cyclopropyl groups, wich are connected to the structure by a single bond or a CH₂-group. Cyclopentyl is preferred.

The compounds of the general formula I to XIII are prepared by methods known per se, as described in the literature (for example in the standard works, such as Houben-Weyl, Methoden der organischen Chemie [Methods of Organic Chemistry], Georg-Thieme-Verlag, Stuttgart), to be precise under reaction conditions which are known and are suitable for the said reactions. Use can be made here of variants which are known per se, but are not mentioned here in greater detail.

Specifically, the compounds of formula I are known or similar to known compounds and may be synthesized in accordance with syntheses in the pertinent prior art.

The invention furthermore relates to a liquid-crystal display containing a liquid-crystalline medium according to the invention, in particular an IPS or FFS display, particularly preferably a FFS or SG-FFS display.

The invention furthermore relates to a liquid-crystal display of the IPS or FFS type comprising a liquid-crystal cell consisting of two substrates, where at least one substrate is transparent to light and at least one substrate has an electrode layer, and a layer, located between the substrates, of a liquid-crystalline medium comprising a polymerised component and a low-molecular-weight component, where the polymerised component is obtainable by polymerisation of one or more polymerisable compounds in the liquid-crystalline medium between the substrates of the liquid-crystal cell, preferably with application of an electrical voltage and where the low-molecular-weight component is a liquid-crystal mixture according to the invention as described above and below.

The displays in accordance with the present invention are preferably addressed by an active matrix (active matrix LCDs, AMDs for short), preferably by a matrix of thin-film transistors (TFTs). However, the liquid crystals according to the invention can also be used in an advantageous manner in displays and devices having other known addressing means.

The invention furthermore relates to a process for the preparation of a liquid-crystalline medium according to the invention by mixing one or more compounds of formula I or its subformulae with one or more low-molecular-weight liquid-crystalline compounds selected from compounds of formulae II, III and VI to IX and optionally additional mesogenic compounds and additives.

The following meanings apply above and below:

The term “FFS” is, unless indicated otherwise, used to represent FFS and SG-FFS displays.

For the purposes of this invention, the term “liquid-crystalline medium” is intended to denote a medium which comprises a liquid-crystal mixture and optionally one or more polymerisable compounds (such as, for example, reactive mesogens). The term “liquid-crystal mixture” (or “host mixture”) is intended to denote a liquid-crystalline mixture which consists exclusively of unpolymerisable, low-molecular-weight compounds, preferably of two or more liquid-crystalline compounds and optionally further additives, such as, for example, chiral dopants or stabilisers.

Particular preference is given to liquid-crystal mixtures and liquid-crystalline media which have a nematic phase, in particular at room temperature.

The term lens refers to classical optical lenses, structured lenses or other beam-steering elements like prisms. An electro-optical lens refers to a electrically switchable optical lens. A switchable lens will be suitable to bring an optical signal in and out of the recognition of an observer, e.g a human eye.

In a preferred embodiment of the present invention, the liquid-crystal medium comprises one or more compounds, preferably having a dielectric anisotropy of greater than 5, selected from formula I-A,

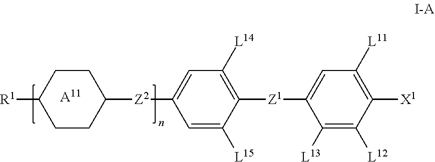

wherein the variables are defined as for formula I above, and
L¹⁴, L¹⁵ are independently H or F, preferably L¹⁴ is F, and preferably L¹⁵ is H,
and more preferably selected from the group of the compounds of the following formulae:

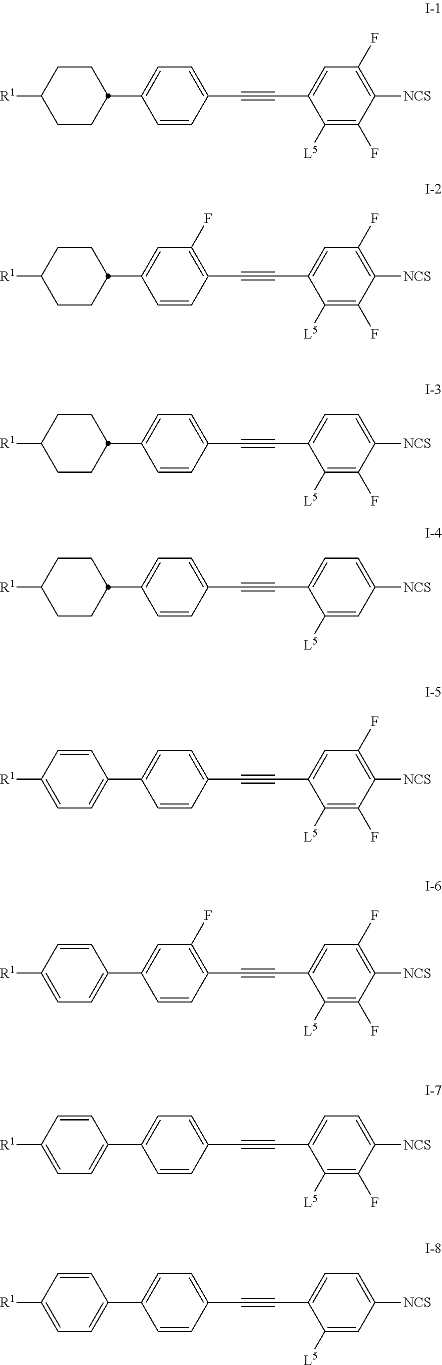

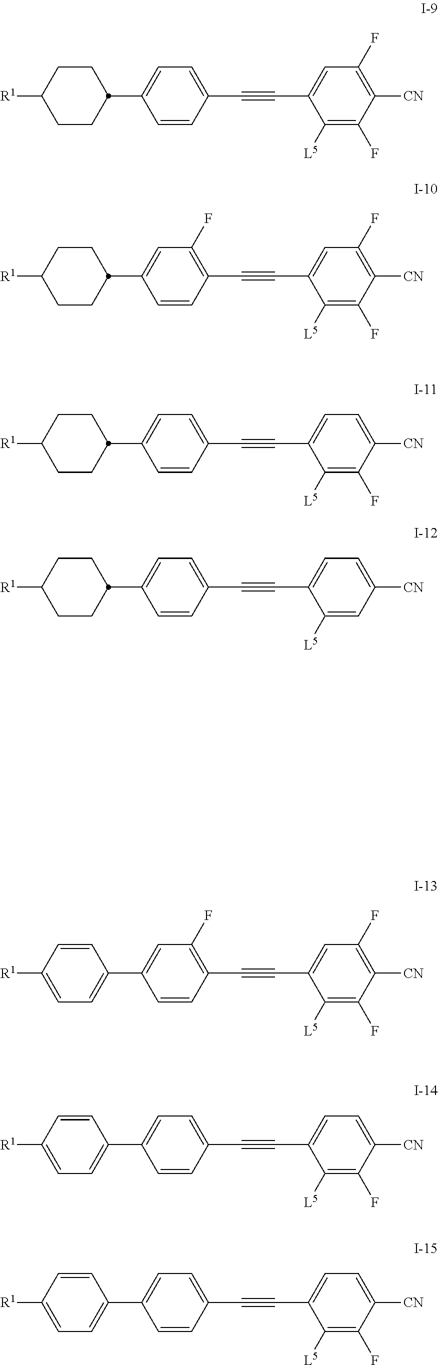

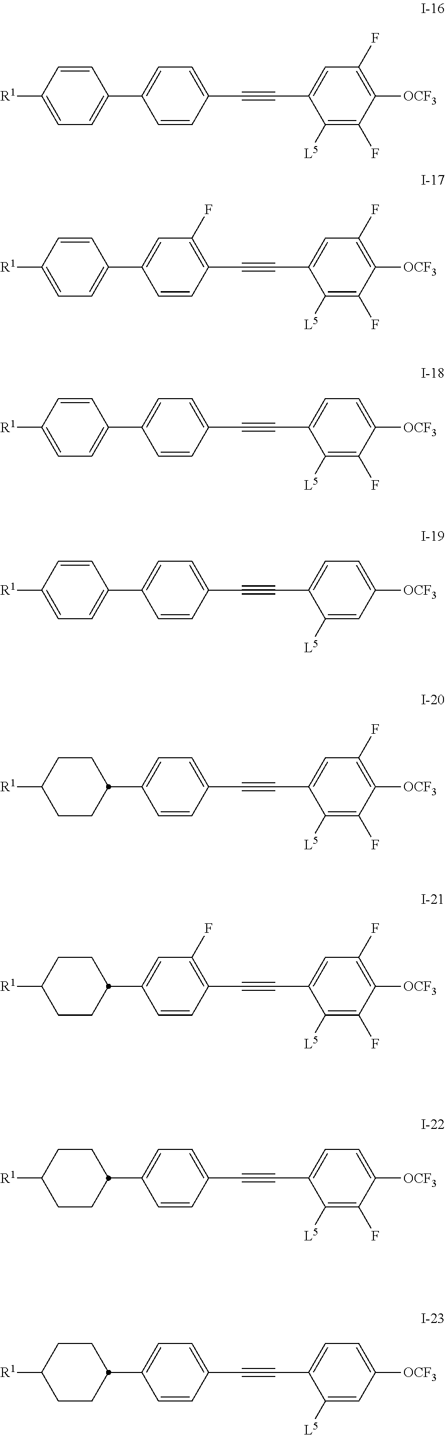

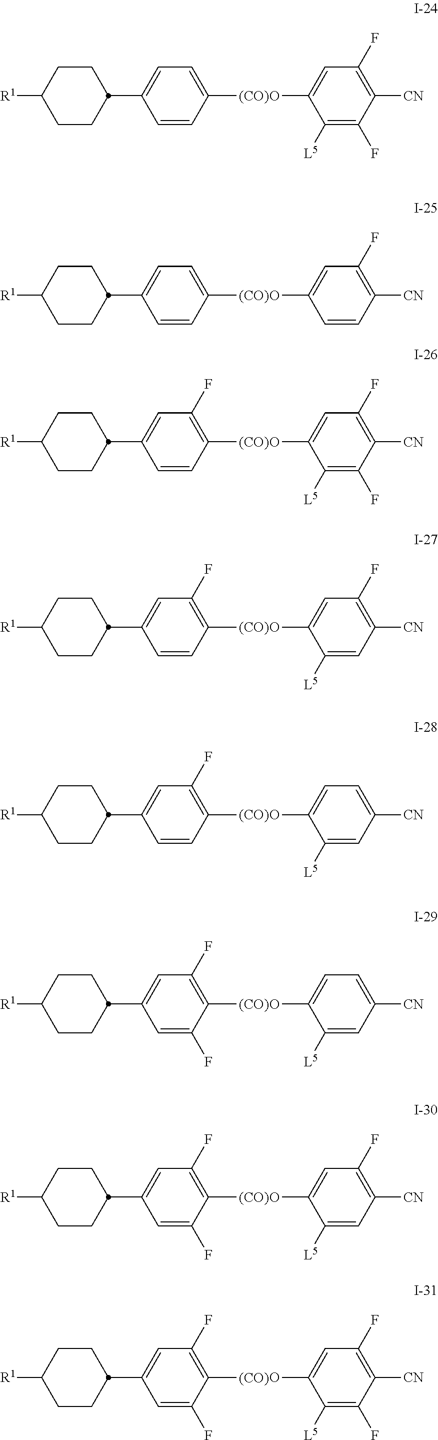

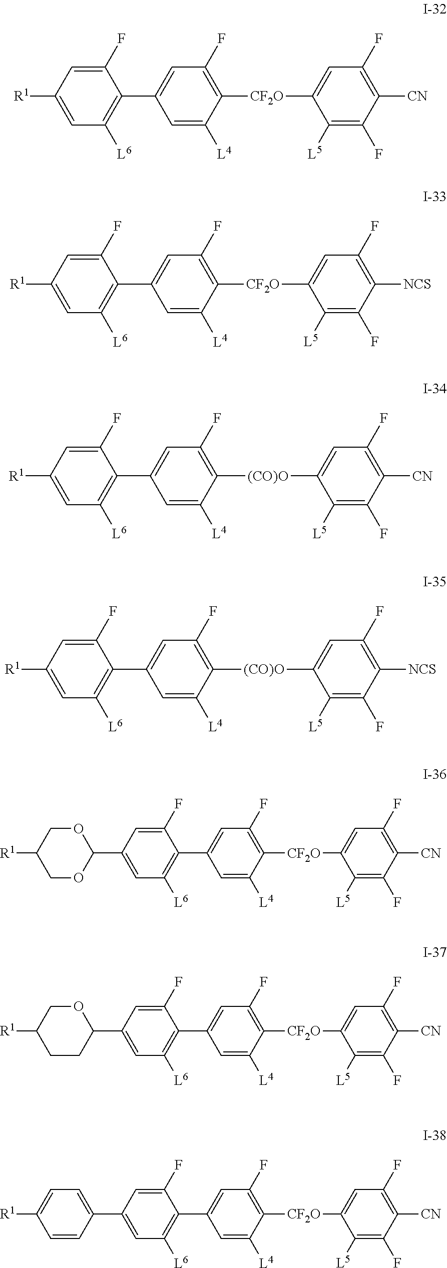

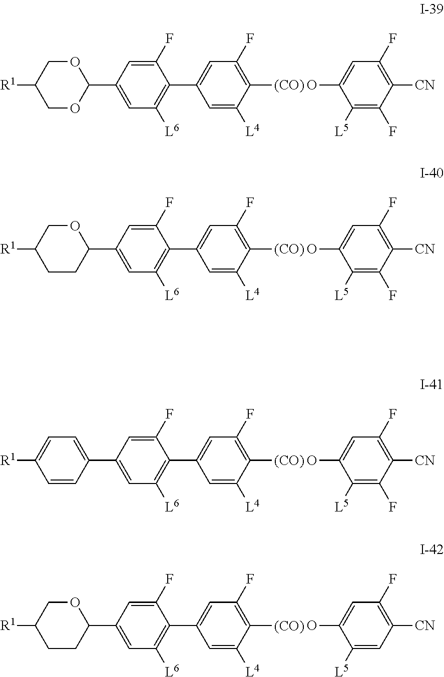

wherein the variables are defined as in formula I above and below,
L⁴ is F or H, preferably H,
L⁵ is H, CH₃ or C₂H₇, preferably H, and
L⁶ is F or H.

In the formulae I, I-A and I-1 to I-42 compounds are preferred, wherein independently:
X¹ is F, CN or SCN, preferably CN or SCN, more preferably CN,
L¹² is F,
L¹³ is H,
L¹⁴ is F,
R¹ is an alkyl radical having 1 to 7 C atoms, wherein one or more CH₂ groups, including terminal C atoms, in this radical may each be replaced, independently of one another, by —C≡C—, —CH═CH—,

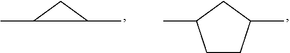

or —O— in such a way that O atoms are not linked directly to one another, and in which, in addition, one or more H atoms may be replaced by F, preferably an alkyl radical having 2 to 7 C atoms.

In a further preferred embodiment of the instant invention the media according to the present invention comprise one or more compounds of formula II, preferably selected from the group of its sub-formulae II-1 and II-2

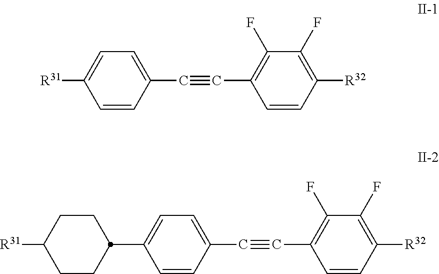

wherein the parameters have the respective meanings given under formula II above and R²¹ preferably is n-alkyl and R²² preferably is alkoxy.

In a further preferred embodiment of the instant invention the media according to the present invention comprise one or more compounds of formula III, preferably selected from the group of compounds of formula III-1 and III-2:

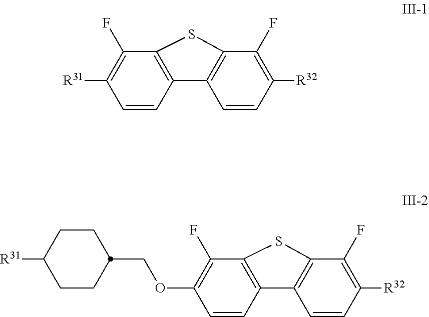

wherein R³¹ and R³² have the meanings given in formula III.

Especially preferred are the compounds of formula III-1. More preferably the mixtures comprise two or more, most preferably three or more compounds of formula III, particularly of formula III-1, most preferably of formula III-1-1.

Further preferred compounds of formula III are selected from the group consisting of the following subformulae,

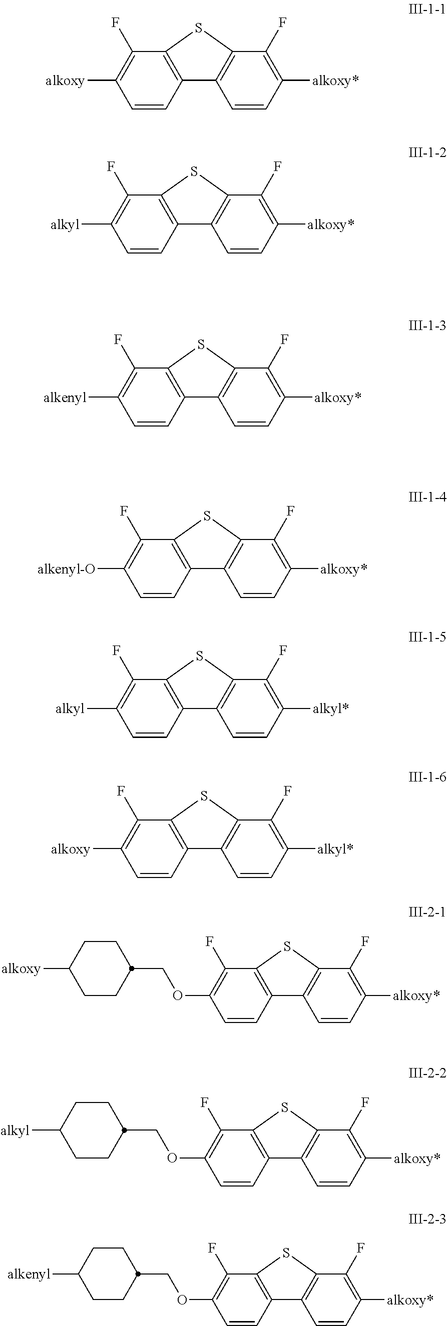

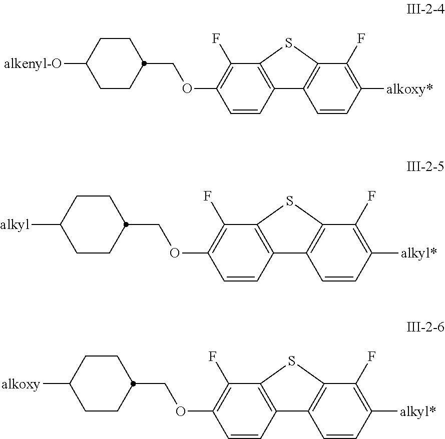

in which the individual radicals, independently of one another, have the following meanings
alkyl a straight-chain alkyl radical having 1-6 C atoms or a branched or cyclic alkyl radical having 3-12, preferably 3-6 C atoms,
alkoxy a straight-chain alkoxy radical having 1-6 C atoms or a branched or cyclic alkoxy radical having 3-12, preferably 3-6 C atoms,
alkenyl a straight-chain alkenyl radical having 2-6 C atoms or a branched or cyclic alkenyl radical having 3-12, preferably 3-6 C atoms,
alkyl* a straight-chain alkyl radical having 1-6 C atoms or a branched or cyclic alkyl radical having 3-12, preferably 3-6 C atoms, and
alkoxy* a straight-chain alkoxy radical having 1-6 C atoms or a branched or cyclic alkoxy radical having 3-12, preferably 3-6 C atoms. Among these, formulae I1-1-1 and III-2-2 are particularly preferred.

The liquid-crystal medium preferably comprises one or more compounds selected from the formulae XIII-1j, XIII-1 k and XIII-1 m, which are preferably selected from the group of the compounds of the formulae XIII-1j-1, XIII-1 k-1, XIII-1 m-1, preferably of the formula XIII-1i-1:

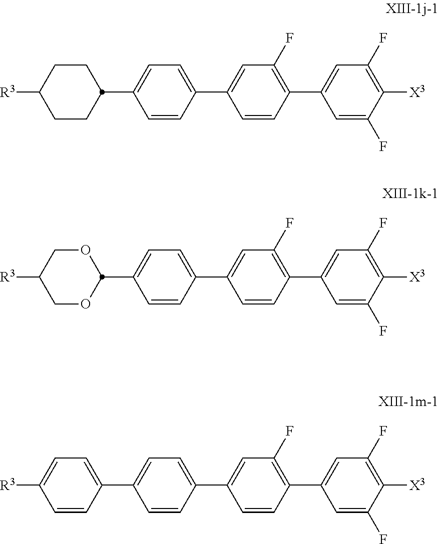

in which the parameters have the meanings given above, and X³ preferably denotes F or —OCF₃.

The liquid-crystal medium preferably comprises one or more compounds of the formula XIII-1k, which are preferably selected from the group of the compounds of the formulae XIII-1m-1 and XIII-1m-2, preferably of the formula XIII-1m-1:

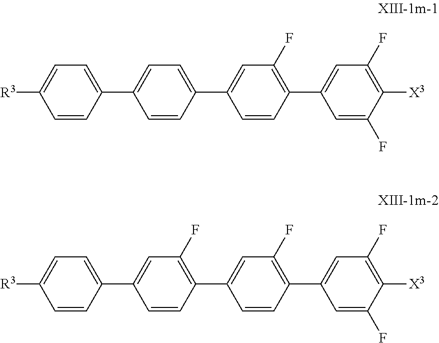

in which the parameters have the meanings given above and wherein the respective rings, and preferably the phenylene rings, optionally may each be substituted by one or two alkyl groups, preferably by methyl and/or ethyl groups, preferably by one methyl group.

The liquid-crystalline media in accordance with the present invention preferably comprise one or more dielectrically neutral compounds having a dielectric anisotropy in the range from −1.5 to 3, preferably selected from the group of the compounds of the formulae VI, VII, VIII and IX.

In the present application, the elements all include their respective isotopes. In particular, one or more H in the compounds may be replaced by D, and this is also particularly preferred in some embodiments. An increased degree of deuteration of the corresponding compounds enables, for example, detection and recognition of the compounds.

In the present application,
alkyl particularly preferably denotes straight-chain alkyl, in particular CH₃—, C₂H₅—, n-C₃H₇—, n-C₄H₉— or n-C₅H₁₁—, and
alkenyl particularly preferably denotes CH₂=CH—, E-CH₃—CH═CH—, CH₂=CH—CH₂—CH₂—, E-CH₃—CH═CH—CH₂—CH₂— or E-(n-C₃H₇)—CH═CH—.

In a preferred embodiment of the present invention, the media according to the invention in each case comprise one or more compounds of formula VI selected from the group of the compounds of the formulae VI-1 to VI-5, preferably one or more compounds each of formula VI-4 or IV-5,

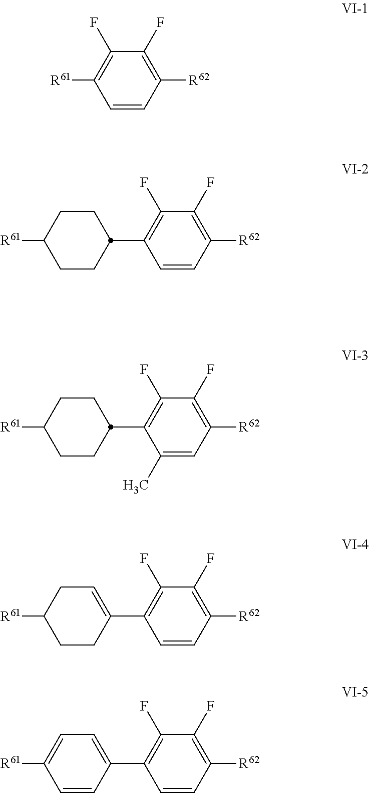

in which the parameters have the respective meanings given above under formula VI, and preferably
in formula VI-1
R⁶¹ and R⁶² independently of each other denote methoxy, ethoxy, propoxy, butoxy (also or pentoxy, preferably ethoxy, butoxy or pentoxy, more preferably ethoxy or butoxy and, most preferably butoxy.
in formulae IV-2 to IV-5
R⁶¹ preferably denotes n-propyl, n-pentyl, vinyl, 1-E-propenyl, but-4-en-1-yl, pent-1-en-1-yl or pent-3-en-1-yl, and
R⁶² an unsubstituted alkoxy radical having 1 to 6 C atoms or an unsubstituted alkyl radical having 1 to 7 C atoms, preferably alkoxy having 2 or 4 C atoms and, most preferably, ethoxy having 2 or 4 C atoms and, most preferably, ethoxy having 2 to 5 C atoms, or, preferably, alkyl having 2 to 4 C atoms.

In a preferred embodiment of the present invention, the media according to the invention in each case comprise one or more compounds of formula VII selected from the group of the compounds of the formulae VII-1 to VII-3, preferably one or more compounds each of the formulae VII-1 and one or more compounds of formula VII-2,

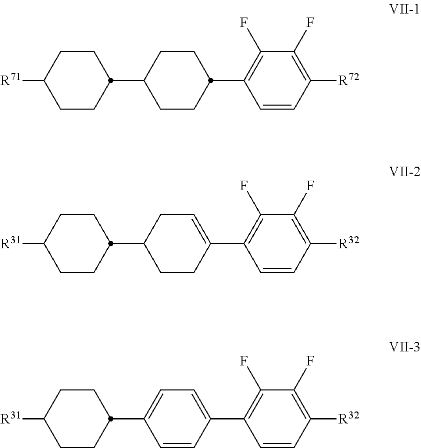

in which the parameters have the respective meanings given above under formula VII, and preferably
R⁷¹ preferably denotes n-propyl, n-pentyl, vinyl, 1-E-propenyl, but-4-en-1-yl, pent-1-en-1-yl or pent-3-en-1-yl, and
R⁷² denotes an unsubstituted alkyl radical having 1 to 7 C atoms, preferably having 2 to 5 C atoms, or, preferably, an unsubstituted alkoxy radical having 1 to 6 C atoms, particularly preferably having 2 or 4 C atoms and, most preferably, ethoxy,
and wherein the respective rings, and preferably the phenylene rings, optionally may each be substituted by one or two alkyl groups, preferably by methyl and/or ethyl groups, preferably by one methyl group.

In a preferred embodiment of the present invention, the media according to the invention in each case comprise one or more compounds of formula VI-1 selected from the group of the following compounds:

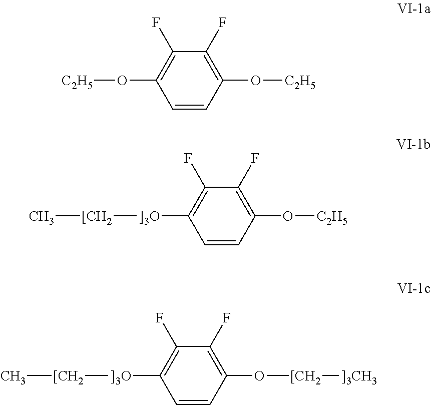

In a preferred embodiment of the present invention, the media according to the invention in each case comprise one or more compounds of formula VI-2 selected from the group of the following compounds:

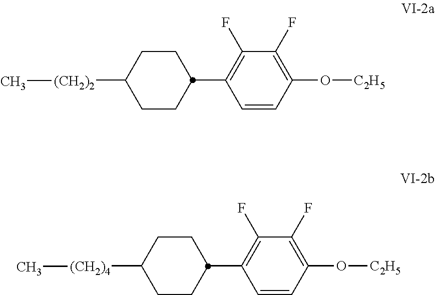

In a preferred embodiment of the present invention, the media according to the invention in each case comprise one or more compounds of formula VII-1 selected from the group of the following compounds:

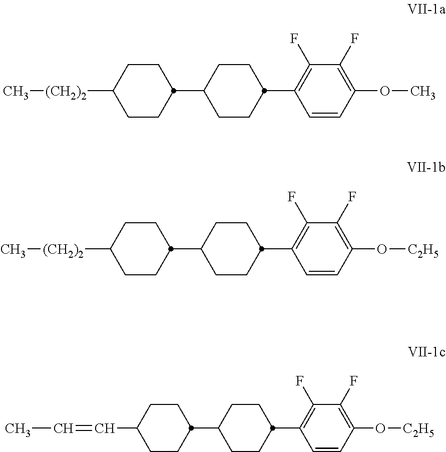

In a preferred embodiment of the present invention, the media according to the invention in each case comprise one or more compounds of formula VII-2 selected from the group of the following compounds:

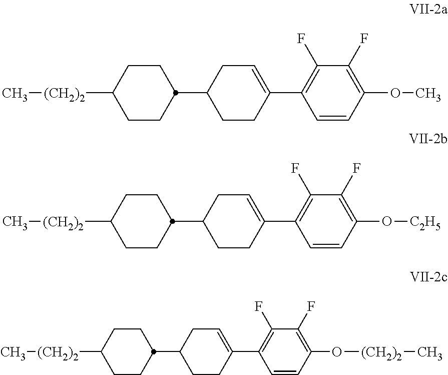

In addition to the compounds of formula I or the preferred sub-formulae thereof, the media in accordance with the present invention may comprise one or more dielectrically negative compounds selected from the group of compounds of the formulae VI and VII preferably in a total concentration in the range from 5% or more to 90% or less, preferably from 10% or more to 80% or less, particularly preferably from 20% or more to 70% or less.

In a preferred embodiment of the present invention, the media according to the invention in each case comprise one or more compounds of formula VIII selected from the group of the compounds of the formulae VIII-1 to VIII-3, preferably one or more compounds each of the formulae VIII-1 and/or one or more compounds of formula VIII-3,

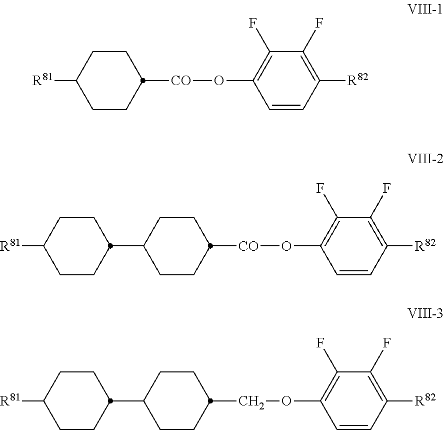

in which the parameters have the respective meanings given above under formula VIII, and preferably
R⁸¹ preferably denotes n-propyl, n-pentyl, vinyl, 1-E-propenyl, but-4-en-1-yl, pent-1-en-1-yl or pent-3-en-1-yl, and
R⁸² denotes an unsubstituted alkyl radical having 1 to 7 C atoms, preferably having 1 to 5 C atoms or an unsubstituted alkoxy radical having 1 to 6 C atoms.

In formulae VIII-1 and VIII-2 R⁸² denotes preferably alkoxy having 2 or 4 C atoms and, most preferably, ethoxy and in formula VIII-3 it denotes preferably alky, preferably methyl, ethyl or n-propyl, most preferably methyl.

In a further preferred embodiment, the medium comprises one or more compounds of formula IV, preferably of formula IVa

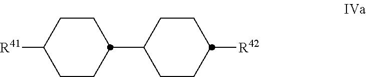

in which
R⁴¹ denotes an unsubstituted alkyl radical having 1 to 7 C atoms or an unsubstituted alkenyl radical having 2 to 7 C atoms, preferably an n-alkyl radical, particularly preferably having 2, 3, 4 or 5 C atoms, and
R⁴² denotes an unsubstituted alkyl radical having 1 to 7 C atoms, an unsubstituted alkenyl radical having 2 to 7 C atoms, or an unsubstituted alkoxy radical having 1 to 6 C atoms, both preferably having 2 to 5 C atoms, an unsubstituted alkenyl radical preferably having 2, 3 or 4 C atoms, more preferably a vinyl radical or 1-propenyl radical and in particular a vinyl radical.

In a particularly preferred embodiment, the medium comprises one or more compounds of formula IV selected from the group of the compounds of the formulae IV-1 to IV-4, preferably of formula IV-1,

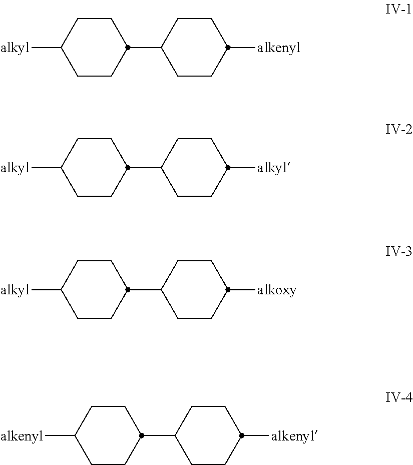

in which
alkyl and alkyl′, independently of one another, denote alkyl having 1 to 7 C atoms, preferably having 2 to 5 C atoms,
alkenyl and alkenyl′, independently of one another, denote alkenyl having 2 to 5 C atoms, preferably having 2 to 4 C atoms, particularly preferably 2 C atoms,
alkenyl′ preferably denotes alkenyl having 2 to 5 C atoms, preferably having 2 to 4 C atoms, particularly preferably having 2 to 3 C atoms, and
alkoxy denotes alkoxy having 1 to 5 C atoms, preferably having 2 to 4 C atoms.

In a particularly preferred embodiment, the media according to the invention comprise one or more compounds of formula IV-1 and/or one or more compounds of formula IV-2.

In a further preferred embodiment, the medium comprises one or more compounds of formula IV, selected from the group of the compounds of the formulae IV-2 and IV-3,

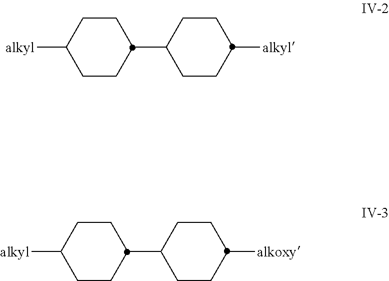

in which
alkyl and alkyl′, independently of one another, denote alkyl having 1 to 7 C atoms, preferably having 2 to 5 C atoms,
alkoxy denotes alkoxy having 1 to 5 C atoms, preferably having 2 to 4 C atoms.

In a further preferred embodiment, the medium comprises one or more compounds of formula V, preferably selected from the group of the compounds of the formulae V-1 to V-7, preferably one or more of formula V-4, V-6 or V-7,

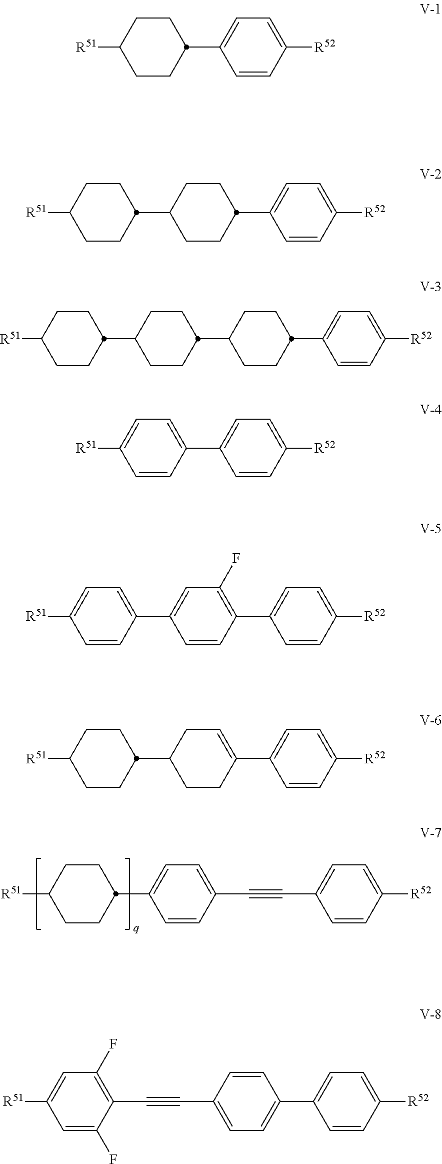

in which the parameters have the meanings given above under formula V, and
q is 0 or 1, preferably 0,
R⁵¹ denotes alkyl having 1 to 7 C atoms or alkenyl having 2 to 7 C atoms, and
R⁵² denotes alkyl having 1 to 7 C atoms, alkenyl having 2 to 7 C atoms or alkoxy having 1 to 6 C atoms, preferably alkyl or alkenyl.

In a further preferred embodiment the medium contains one or more compounds of the formula V-1 selected from the following formulae:

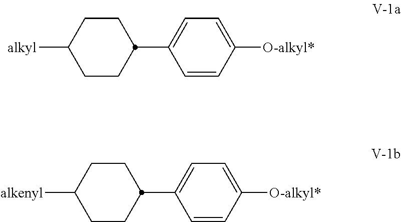

in which “alkyl” has the definition given above, and is preferably methyl, ethyl, propyl or butyl. Particular preference is given to compounds of the formula V-1a.

In a further preferred embodiment the medium contains one or more compounds of the formula V-4 in which at least one of the R⁵¹ and R⁵² radicals is alkenyl having 2 to 6 carbon atoms, preferably those selected from the following formulae:

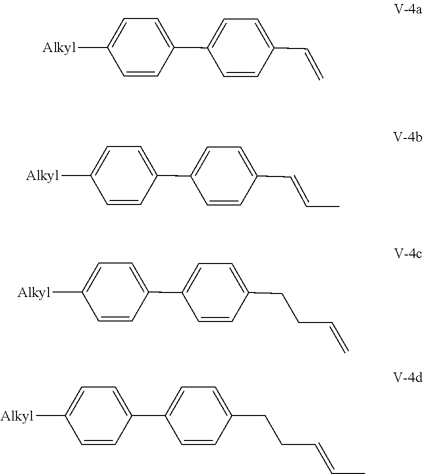

in which “Alkyl” has the definition given above, and is preferably methyl or ethyl. Particular preference is given to compounds of the formula V-3d.

In a further preferred embodiment, the medium comprises one or more compounds of formula V-5 selected from the group of the compounds of the formulae V-5a to V-5c,

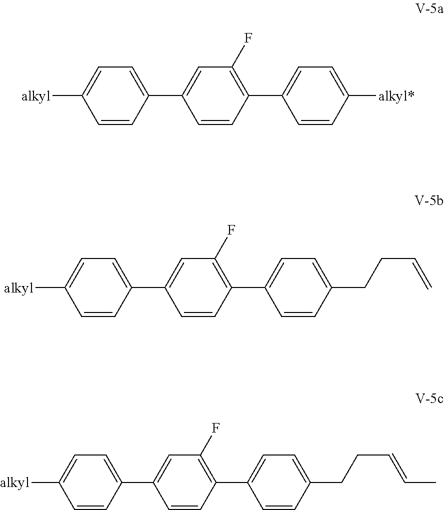

in which
alkyl and alkyl* are each independently straight-chain alkyl radical having 1 to 6 carbon atoms, especially methyl, ethyl, n-propyl and pentyl.

The liquid crystalline medium preferably comprises two, three or more compounds selected from the group of compounds of formulae V-4a, V-4b and V-4c.

In a further preferred embodiment, the medium comprises one or more compounds of formula V-6 selected from the group of the compounds of the formulae V-6a to V-6c, preferably V-6a:

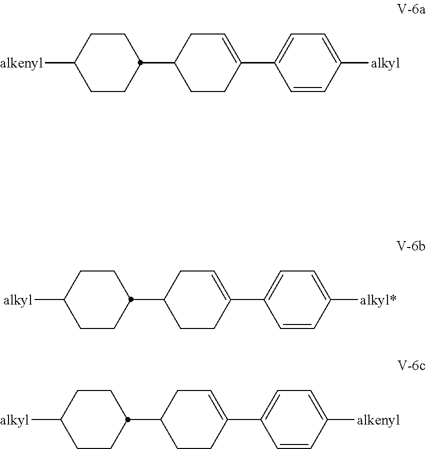

in which
alkyl and alkyl* are each independently straight-chain alkyl radical having 1 to 6 carbon atoms, especially methyl, ethyl or n-propyl, and
alkenyl preferably denotes alkenyl having 2 to 5 C atoms, preferably having 2 to 4 C atoms, particularly preferably vinyl.

In a further preferred embodiment the medium contains one or more compounds selected from the compounds of formula V-7 and V-8, more preferably selected from the following formulae:

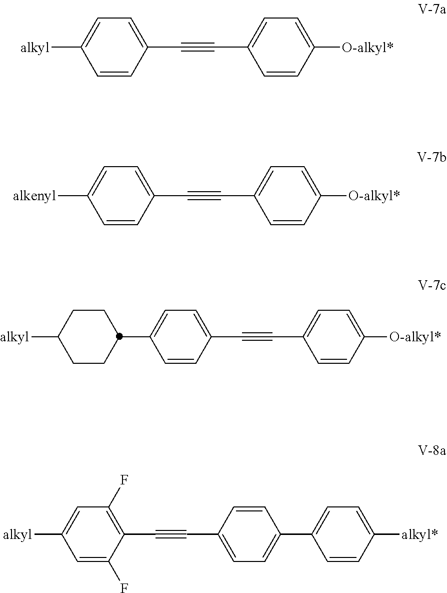

in which “alkyl” has the definition given above, and is preferably methyl, ethyl, propyl or butyl. Particular preference is given to compounds of the formula V-7a.

The media according to the invention preferably comprise the following compounds in the total concentrations indicated:
5-50% by weight of one or more compounds selected from the group of the compounds of formula I and
0-40% by weight of one or more compounds of formula II, preferably selected from the group of the compounds of the formulae XII-1 and XII-2 and/or
1-50% by weight of one or more compounds of formula III, and/or
0-10% by weight of one or more compounds of formula VI, and/or
0-40% by weight of one or more compounds of formula VII, and/or
0-20% by weight of one or more compounds of formula VIII, and/or
0-20% by weight of one or more compounds of formula IX, and/or
where the total content of all compounds of formula I, II, III and of formulae VI to IX, which are present in the medium, preferably is 95% or more, more preferably 97% or more and, most preferably, 100%.

The latter condition holds for all media according to the present application.

The medium according to the invention in a particularly preferred embodiment comprises
one or more compounds of formula I in a total concentration in the range from 5% or more to 40% or less, preferably in the range from 10% or more to 35% or less, and
one or more compounds of formula II in a total concentration in the range from 0% or more to 30% or less, preferably in the range from 10% or more to 30% or less, and
one or more compounds of formula III in a total concentration in the range from 0% or more to 30% or less, preferably in the range from 4% or more to 30% or less, and
one or more compounds of formula VI in a total concentration in the range from 0% or more to 15% or less, preferably in the range from 0% or more to 5% or less, and/or
one or more compounds of formula VII in a total concentration in the range from 0% or more to 25% or less, preferably in the range from 0% or more to 10% or less, and/or
one or more compounds of formula VIII in a total concentration in the range from 0% or more to 30% or less, and/or
one or more compounds of formula IX in a total concentration in the range from 0% or more to 35% or less, preferably in the range from 1% or more to 20% or less.

The present invention also relates to electro-optical displays or electro-optical components which contain liquid-crystalline media according to the invention. Preference is given to electro-optical displays which are based on the FFS, IPS, VA or ECB effect, preferably on the IPS or FFS effect, and in particular those which are addressed by means of an active-matrix addressing device.

Accordingly, the present invention likewise relates to the use of a liquid-crystalline medium according to the invention in an electro-optical display or in an electro-optical component, and to a process for the preparation of the liquid-crystalline media according to the invention, characterised in that one or more compounds of formula I are mixed with one or more additional mesogenic compounds and optionally one ore more additives.

Besides compounds of the formulae I, II, III, VI, VII, VIII and IX other constituents may also be present, for example in an amount of up to 45%, but preferably up to 35%, in particular up to 10%, of the mixture as a whole.

The liquid-crystal media in accordance with the present invention may comprise one or more chiral compounds.

Particularly preferred embodiments of the present invention meet one or more of the following conditions,
where the acronyms (abbreviations) are explained in Tables A to C and illustrated by examples in Table D.

Preferably the media according to the present invention fulfil one or more of the following conditions.
i. The liquid-crystalline medium has a birefringence of 0.2 or more, particularly preferably 0.22 or more.
ii. The liquid-crystalline medium has a birefringence of 0.28 or less, particularly preferably 0.25 or less.
iii. The liquid-crystalline medium has a birefringence in the range from 0.21 or more to 0.25 or less.
iv. The liquid-crystalline medium comprises one or more particularly preferred compounds of formula 1, preferably selected from the (sub-) formulae I-A or 1-1 and following.
v. The liquid-crystalline medium comprises one or more particularly preferred compounds of formula III, preferably of formula III-1.
vi. The total concentration of the compounds of formula 1, III and V-7 in the mixture as a whole is 30% or more, preferably 35% or more, and preferably 60% or less, particularly preferably 55% or less, and very particularly preferably in the range from 25% or more to 45% or less.
vii. The liquid-crystalline medium comprises one or more compounds of formula V, preferably selected from the formulae V-1, V-4 and V-5, preferably in a total concentration of 3% or more, in particular 5% or more, and very particularly preferably 8% or more.
viii. The liquid-crystalline medium comprises one or more stabilizer compounds having a benzotriazole ring,
   preferably of any of the following structures

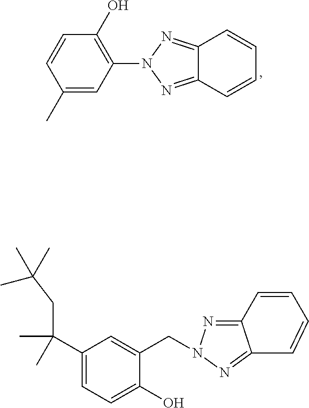 [SMILES: Cc1ccc(O)c(-n2nc3ccccc3n2)c1 ; CC(C)(C)CC(C)(C)c1ccc(O)c(Cn2nc3ccccc3n2)c1]

preferably in a total concentration in the range from 0% or more to 1% or less, preferably up to 0.8%, and very particularly preferably in the range from 0.4% or more to 0.8% or less, and/or
ix. The liquid-crystalline medium comprises a phenol type stabilizing additive, preferably selected from the following structures,

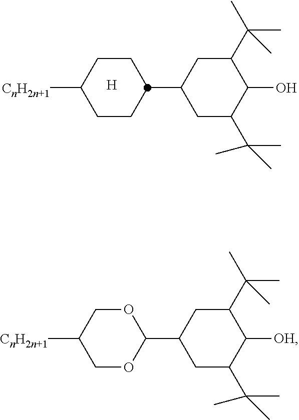

wherein n is 1 to 12, preferably 3, preferably in a total concentration of 0.01% or more, in particular 0.03% or more.

The invention furthermore relates to an electro-optical display having active-matrix addressing, characterised in that it contains, as dielectric, a liquid-crystalline medium in accordance with the present invention.

The liquid-crystal mixture preferably has a nematic phase range having a width of at least 70 degrees.

The rotational viscosity γ₁ is preferably 350 mPa·s or less, preferably 250 mPa·s or less and, in particular, 150 mPa·s or less.

The mixtures according to the invention are suitable for all IPS and FFS-TFT applications using dielectrically positive liquid crystalline media, such as, e.g. XB-FFS.

The liquid-crystalline media according to the invention preferably virtually completely consist of 4 to 15, in particular 5 to 12, and particularly preferably 10 or less, compounds. These are preferably selected from the group of the compounds of the formulae I, II, III, VI, VII, VIII and IX.

The liquid-crystalline media according to the invention may optionally also comprise more than 18 compounds. In this case, they preferably comprise 18 to 25 compounds.

In a preferred embodiment, the liquid-crystal media according to the invention predominantly comprise, preferably essentially consist of and, most preferably, virtually completely consist of compounds, which do not comprise a cyano group.

In a preferred embodiment, the liquid-crystal media according to the invention comprise compounds selected from the group of the compounds of the formulae I, II, III, VI, VII, VIII and IX. They preferably consist predominantly, particularly preferably essentially and very particularly preferably virtually completely of the compounds of the said formulae.

The liquid-crystal media according to the invention preferably have a nematic phase from in each case at least −10° C. or less to 70° C. or more, particularly preferably from −20° C. or less to 80° C. or more, very particularly preferably from −30° C. or less to 85° C. or more and most preferably from −40° C. or less to 90° C. or more.

The expression “have a nematic phase” here means on the one hand that no smectic phase and no crystallisation are observed at low temperatures at the corresponding temperature and on the other hand that no clearing occurs on heating out of the nematic phase. The investigation at low temperatures is carried out in a flow viscometer at the corresponding temperature and checked by storage in test cells having a cell thickness corresponding to the electro-optical application for at least 100 hours. If the storage stability at a temperature of −20° C. in a corresponding test cell is 1,000 h or more, the medium is regarded as stable at this temperature. At temperatures of −30° C. and −40° C., the corresponding times are 500 h and 250 h respectively. At high temperatures, the clearing point is measured in capillaries by conventional methods.

In a preferred embodiment, the liquid-crystal media according to the invention are characterised by optical anisotropy values in the moderate to high range, which are for example very suitable for optical lenses made from liquid crystal materials. The birefringence values are preferably in the range from 0.2 or more to 0.35 or less, particularly preferably in the range from 0.2 or more to 0.32 or less and very particularly preferably in the range from 0.22 or more to 0.30 or less.

In a preferred embodiment, the liquid-crystal media according to the invention are characterised by optical anisotropy values in the moderate range, which are for example very suitable for LC displays. The birefringence values are preferably in the range from 0.09 or more to 0.22 or less, particularly preferably in the range from 0.10 or more to 0.20 or less and very particularly preferably in the range from 0.12 or more to 0.18 or less.

In this embodiment, the liquid-crystal media according to the invention have a positive dielectric anisotropy Δε, which usually is in the range from 1.5 to 15, preferably it is in the range from 2.5 or more to 12 or less, more preferably to 8 or less, particularly preferably from 3 or more to 8 or less.

The liquid-crystal media according to the invention preferably have relatively low values for the threshold voltage (V₀) in the range from 1.0 V or more to 5.0 V or less, preferably to 2.5 V or less, preferably from 1.2 V or more to 2.2 V or less, particularly preferably from 1.3 V or more to 2.0 V or less.

In addition, the liquid-crystal media according to the invention have high values for the VHR in liquid-crystal cells.

In general, liquid-crystal media having a low addressing voltage or threshold voltage here have a lower VHR than those having a higher addressing voltage or threshold voltage, and vice versa.

These preferred values for the individual physical properties are preferably also in each case maintained by the media according to the invention in combination with one another.

In the present application, the term “compounds”, also written as “compound(s)”, means both one and also a plurality of compounds, unless explicitly indicated otherwise.

For the present invention, the following definitions apply in connection with the specification of the constituents of the compositions, unless indicated otherwise in individual cases:
“comprise”: the concentration of the constituents in question in the composition is preferably 5% or more, particularly preferably 10% or more, very particularly preferably 20% or more,
“predominantly consist of”: the concentration of the constituents in question in the composition is preferably 50% or more, particularly preferably 55% or more and very particularly preferably 60% or more,
“essentially consist of”: the concentration of the constituents in question in the composition is preferably 80% or more, particularly preferably 90% or more and very particularly preferably 95% or more, and
“virtually completely consist of”: the concentration of the constituents in question in the composition is preferably 98% or more, particularly preferably 99% or more and very particularly preferably 100.0%.

This applies both to the media as compositions with their constituents, which can be groups of compounds as well as individual compounds, and also to the groups of compounds with their respective constituents, the compounds. Only in relation to the concentration of an individual compound relative to the medium as a whole does the term comprise mean: the concentration of the compound or compounds in question is preferably 1% or more, particularly preferably 2% or more, very particularly preferably 4% or more.

For the present invention, “≤” means less than or equal to, preferably less than, and “≥” means greater than or equal to, preferably greater than.

For the present invention

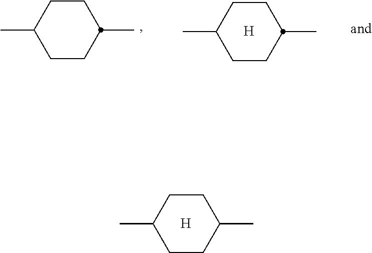

denote trans-1,4-cyclohexylene,

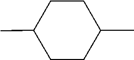

denotes a mixture of both cis- and trans-1,4-cyclohexylene and

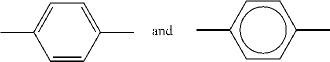

denote 1,4-phenylene.

Throughout this application 1,3-cyclopentenylene is a moiety selected from the group of the formulae

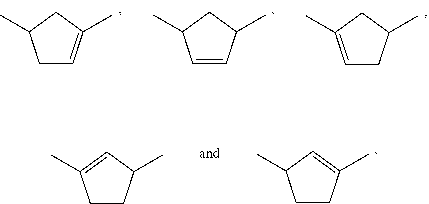

preferably

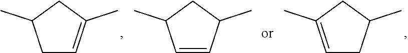

most preferably

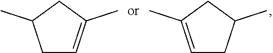

For the present invention, the expression “dielectrically positive compounds” means compounds having a Δε of >1.5, the expression “dielectrically neutral compounds” means compounds having −1.5≤Δε≤1.5 and the expression “dielectrically negative compounds” means compounds having Δε<−1.5. The dielectric anisotropy of the compounds is determined here by dissolving 10% of the compounds in a liquid-crystalline host and determining the capacitance of the resultant mixture in each case in at least one test cell having a cell thickness of 20 μm with homeotropic and with homogeneous surface alignment at 1 kHz. The measurement voltage is typically 0.5 V to 1.0 V, but is always lower than the capacitive threshold of the respective liquid-crystal mixture investigated.

The host mixture used for dielectrically positive and dielectrically neutral compounds is ZLI-4792 and that used for dielectrically negative compounds is ZLI-2857, both from Merck KGaA, Germany. The values for the respective compounds to be investigated are obtained from the change in the dielectric constant of the host mixture after addition of the compound to be investigated and extrapolation to 100% of the compound employed. The compound to be investigated is dissolved in the host mixture in an amount of 10%. If the solubility of the substance is too low for this purpose, the concentration is halved in steps until the investigation can be carried out at the desired temperature.

The liquid-crystal media according to the invention may, if necessary, also comprise further additives, such as, for example, stabilisers and/or pleochroitic, e.g. dichroitic, dyes and/or chiral dopants in the usual amounts. The amount of these additives employed is preferably in total 0% or more to 10% or less, based on the amount of the entire mixture, particularly preferably 0.1% or more to 6% or less. The concentration of the individual compounds employed is preferably 0.1% or more to 3% or less. The concentration of these and similar additives is generally not taken into account when specifying the concentrations and concentration ranges of the liquid-crystal compounds in the liquid-crystal media.

In a preferred embodiment, the liquid-crystal media according to the invention comprise a polymer precursor which comprises one or more reactive compounds, preferably reactive mesogens, and, if necessary, also further additives, such as, for example, polymerisation initiators and/or polymerisation moderators, in the usual amounts. The amount of these additives employed is in total 0% or more to 10% or less, based on the amount of the entire mixture, preferably 0.1% or more to 2% or less. The concentration of these and similar additives is not taken into account when specifying the concentrations and concentration ranges of the liquid-crystal compounds in the liquid-crystal media.

The compositions consist of a plurality of compounds, preferably 3 or more to 30 or fewer, particularly preferably 6 or more to 20 or fewer and very particularly preferably 10 or more to 16 or fewer compounds, which are mixed in a conventional manner. In general, the desired amount of the compounds used in lesser amount is dissolved in the compounds making up the principal constituent of the mixture. This is advantageously carried out at elevated temperature. If the selected temperature is above the clearing point of the principal constituent, completion of the dissolution operation is particularly easy to observe. However, it is also possible to prepare the liquid-crystal mixtures in other conventional ways, for example using pre-mixes or from a so-called “multi-bottle system”.

The mixtures according to the invention exhibit very broad nematic phase ranges having clearing points of 65° C. or more, very favourable values for the capacitive threshold, relatively high values for the holding ratio and at the same time very good low-temperature stabilities at −30° C. and −40° C. Furthermore, the mixtures according to the invention are distinguished by low rotational viscosities γ₁.

It goes without saying to the person skilled in the art that the media according to the invention for use in VA, IPS, FFS or PALC displays may also comprise compounds in which, for example, H, N, O, Cl, F have been replaced by the corresponding isotopes.

The structure of the FFS liquid-crystal displays according to the invention corresponds to the usual geometry, as described, for example, in US 2002/0041354 A1.

The liquid-crystal phases according to the invention can be modified by means of suitable additives in such a way that they can be employed in any type of, for example, IPS and FFS LCD display that has been disclosed to date.

Table E below indicates possible dopants which can be added to the mixtures according to the invention. If the mixtures comprise one or more dopants, it is (they are) employed in amounts of 0.01% to 4%, preferably 0.1% to 1.0%.

Stabilisers which can be added, for example, to the mixtures according to the invention, preferably in amounts of 0.01% to 6%, in particular 0.1% to 3%, are shown below in Table F.

For the purposes of the present invention, all concentrations are, unless explicitly noted otherwise, indicated in percent by weight and relate to the corresponding mixture as a whole or mixture constituents, again a whole, unless explicitly indicated otherwise. In this context the term “the mixture” describes the liquid crystalline medium.

All temperature values indicated in the present application, such as, for example, the melting point T(C,N), the smectic (S) to nematic (N) phase transition T(S,N) and the clearing point T(N,I), are indicated in degrees Celsius (° C.) and all temperature differences are correspondingly indicated in differential degrees (° or degrees), unless explicitly indicated otherwise.

The birefringence Δn herein is defined by the following equation

Δn=nₑ−nₒ
wherein nₑ is the extraordinary refractive index and nₒ is the ordinary refractive index. The extraordinary refractive index nₑ and the ordinary refractive index nₒ can be measured using an Abbe refractometer.
Δε is defined as (ε∥−ε_{⊥}). The dielectric permittivity of the compounds is determined from the change of the respective values of a host medium upon addition of the compounds of interest. The values are extrapolated to a concentration of the compounds of interest of 100%. A typical host medium is ZLI-4792 or ZLI-2857 both commercially available from Merck, Darmstadt.

For the present invention, the term “threshold voltage” relates to the capacitive threshold (V₀), also known as the Freedericks threshold, unless explicitly indicated otherwise.

All physical properties are and have been determined in accordance with “Merck Liquid Crystals, Physical Properties of Liquid Crystals”, status November 1997, Merck KGaA, Germany, and apply for a temperature of 20° C., and Δn is determined at 436 nm, 589 nm and at 633 nm, and Δε at 1 kHz, unless explicitly indicated otherwise in each case.

The electro-optical properties, for example the threshold voltage (V₀) (capacitive measurement), are, as is the switching behaviour, determined in test cells produced at Merck Japan. The measurement cells have soda-lime glass substrates and are constructed in an ECB or VA configuration with polyimide alignment layers (SE-1211 with diluent **26 (mixing ratio 1:1), both from Nissan Chemicals, Japan), which have been rubbed perpendicularly to one another and effect homeotropic alignment of the liquid crystals. The surface area of the transparent, virtually square ITO electrodes is 1 cm².

Unless indicated otherwise, a chiral dopant is not added to the liquid-crystal mixtures used, but the latter are also particularly suitable for applications in which doping of this type is necessary.

The rotational viscosity is determined using the rotating permanent magnet method and the flow viscosity in a modified Ubbelohde viscometer. For liquid-crystal mixtures ZLI-2293, ZLI-4792 and MLC-6608, all products from Merck KGaA, Darmstadt, Germany, the rotational viscosity values determined at 20° C. are 161 mPa·s, 133 mPa·s and 186 mPa·s respectively, and the flow viscosity values (ν) are 21 mm²·s⁻¹, 14 mm²·s⁻¹ and 27 mm²·s⁻¹, respectively.

The dispersion of the materials may for practical purposes be conveniently characterized in the following way, which is used throughout this application unless explicitly stated otherwise. The values of the birefringence are determined at a temperature of 20° C. at several fixed wavelengths using a modified Abbé refractometer with homeotropically aligning surfaces on the sides of the prisms in contact with the material. The birefringence values are determined at the specific wavelength values of 436 nm (respective selected spectral line of a low pressure mercury lamp), 589 nm (sodium “D” line) and 633 nm (wavelength of a HE-Ne laser (used in combination with an attenuator/diffusor in order to prevent damage to the eyes of the observers. In the following table Δn is given at 589 nm and Δ(Δn) is given as Δ(Δn)=Δn(436 nm)−Δn(633 nm).

The following symbols are used, unless explicitly indicated otherwise:
V₀ threshold voltage, capacitive [V] at 20° C.,
nₑ extraordinary refractive index measured at 20° C. and 589 nm,
nₒ ordinary refractive index measured at 20° C. and 589 nm,
Δn optical anisotropy measured at 20° C. and 589 nm,
λ wavelength λ [nm],
Δn(λ) optical anisotropy measured at 20° C. and wavelength λ,
Δ(Δn) change in optical anisotropy defined as:

$$Δ n ( 20 ° C . , 436 nm ) - Δ n ( 20 ° C . , 633 nm ) ,$$

Δ(Δn*) “relative change in optical anisotropy” defined as:

$$Δ ( Δ n ) / Δ n ( 20 ° C . , 589 nm ) ,$$

ε_{⊥} dielectric susceptibility perpendicular to the director at 20° C. and 1 kHz,
ε∥ dielectric susceptibility parallel to the director at 20° C. and 1 kHz,
Δε dielectric anisotropy at 20° C. and 1 kHz,
T(N,I) or clp. clearing point [° C.],
ν flow viscosity measured at 20° C. [mm²·s⁻¹],
γ₁ rotational viscosity measured at 20° C. [mPa·s],
K₁ elastic constant, “splay” deformation at 20° C. [pN],
K₂ elastic constant, “twist” deformation at 20° C. [pN](K₂≈½ K₁),
K₃ elastic constant, “bend” deformation at 20° C. [pN],
K_{av.} average elastic constant at 20° C. [pN] defined here as

$${K}_{av .} ≡ ( 3 / 2 {K}_{1} + {K}_{3} ) / 3 \approx ( {K}_{1} + {K}_{2} + {K}_{3} ) / 3.$$

LTS low-temperature stability of the phase, determined in test cells,
VHR voltage holding ratio,
ΔVHR decrease in the voltage holding ratio, and
Sᵣₑₗ relative stability of the VHR,

The following examples explain the present invention without limiting it. However, they show the person skilled in the art preferred mixture concepts with compounds preferably to be employed and the respective concentrations thereof and combinations thereof with one another. In addition, the examples illustrate the properties and property combinations that are accessible.

For the present invention and in the following examples, the structures of the liquid-crystal compounds are indicated by means of acronyms, with the transformation into chemical formulae taking place in accordance with Tables A to C below. All radicals CₙH₂ₙ₊₁, CₘH₂ₘ₊₁ and CₗH₂ₗ₊₁ or CₙH₂ₙ, CₘH₂ₘ and CₗH₂ₗ are straight-chain alkyl radicals or alkylene radicals, in each case having n, m and l C atoms respectively. Preferably n, m and l are independently of each other 1, 2, 3, 4, 5, 6, or 7. Table A shows the codes for the ring elements of the nuclei of the compound, Table B lists the bridging units, and Table C lists the meanings of the symbols for the left- and right-hand end groups of the molecules. The acronyms are composed of the codes for the ring elements with optional linking groups, followed by a first hyphen and the codes for the left-hand end group, and a second hyphen and the codes for the right-hand end group. Table D shows illustrative structures of compounds together with their respective abbreviations.

TABLE A
Ring elements

| | | | |
|---|---|---|---|
| C | 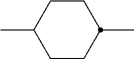 | | |
| D | 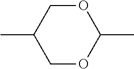 | DI | 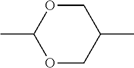 |
| A | 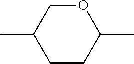 | AI | 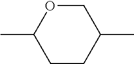 |
| P | 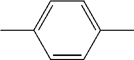 | | |
| G | 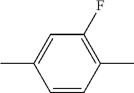 | GI | 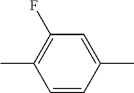 |
| U | 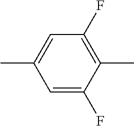 | UI | 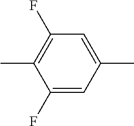 |
| Y | 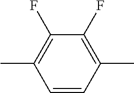 | | |
| P(F, Cl)Y | 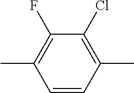 | P(Cl,F)Y | 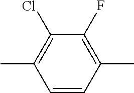 |
| np | 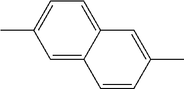 | | |
| n3f | 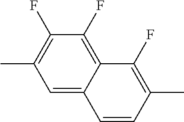 | nN3fl | 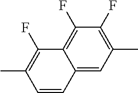 |
| th | 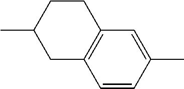 | thl | 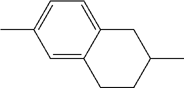 |
| tH2f | 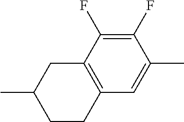 | tH2fl | 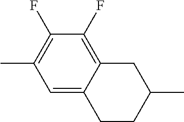 |
| o2f | 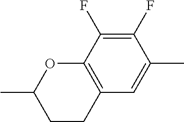 | o2fl | 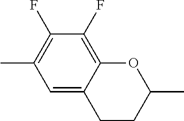 |
| dh | 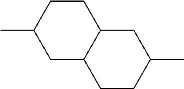 | nf | 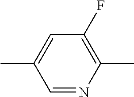 |
| B | 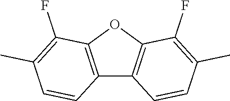 | B(S) | 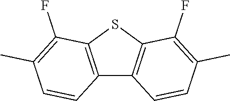 |
| O | 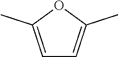 | S | 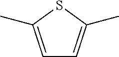 |
| K | 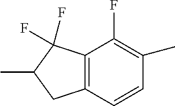 | KI | 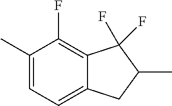 |
| L | 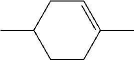 | LI | 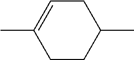 |
| F | 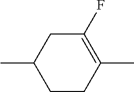 | FI | 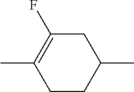 |
| 6 Bh | 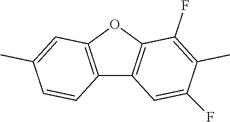 | Bh(S) | 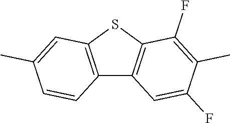 |
| Bf | 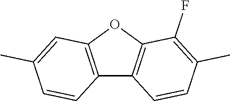 | Bf(S) | 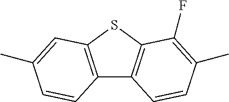 |
| Bfi | 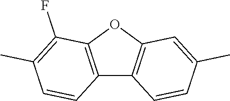 | Bfi(S) | 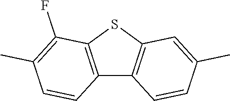 |

TABLE B
Bridging units

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH₂—O— | OI | —O—CH₂— |
| Q | —CF₂—O— | QI | —O—CF₂— |

TABLE C
End groups

| On the left individually | | On the right individually | |
|---|---|---|---|
| or in combination | | or in combination | |
| -n- | CₙH₂ₙ₊₁— | -n | —CₙH₂ₙ₊₁ |
| -nO— | CₙH₂ₙ₊₁—O— | —On | —O—CₙH₂ₙ₊₁ |
| —V— | CH₂═CH— | —V | —CH═CH₂ |
| -nV— | CₙH₂ₙ₊₁—CH═CH— | -nV | —CₙH₂ₙ—CH═CH₂ |
| —Vn- | CH₂═CH—CₙH₂ₙ— | —Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| —N— | N≡C— | —N | —C≡N |
| —S— | S═C═N— | —S | —N═C═S |
| —F— | F— | —F | —F |
| —CL— | Cl— | —CL | —Cl |
| —M— | CFH₂— | —M | —CFH₂ |
| —D— | CF₂H— | —D | —CF₂H |
| —T— | CF₃— | —T | —CF₃ |
| —MO— | CFH₂O— | —OM | —OCFH₂ |
| —DO— | CF₂HO— | —OD | —OCF₂H |
| —TO— | CF₃O— | —OT | —OCF₃ |
| —A— | H—C≡C— | —A | —C≡C—H |
| -nA— | CₙH₂ₙ₊₁—C≡C— | —An | —C≡C—CₙH₂ₙ₊₁ |
| —NA— | N≡C—C≡C— | —AN | —C≡C—C≡N |
| -cp- | cyclopentyl | -cp | cyclopentyl |
| -cpr- | cyclopropyl | -cpr | cyclopropyl |

| On the left only in combination | | On the right only in combination | |
|---|---|---|---|
| - . . . n . . . - | —CₙH₂ₙ— | - . . . n . . . | —CₙH₂ₙ— |
| - . . . M . . . - | —CFH— | - . . . M . . . | —CFH— |
| - . . . D . . . - | —CF₂— | - . . . D . . . | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |
| - . . . O . . . - | —O— | - . . . O . . . - | —O— |

in which n and m are each integers, and the three dots “ . . . ” are placeholders for other abbreviations from this table.

Besides the compounds of formula B, the mixtures according to the invention preferably comprise one or more compounds of the compounds mentioned below.

The following abbreviations are used:
(n, m, k and l are, independently of one another, each an integer, preferably 1 to 9 preferably 1 to 7, k and I possibly may be also 0 and preferably are 0 to 4, more preferably 0 or 2 and most preferably 2, n preferably is 1, 2, 3, 4 or 5, in the combination “-nO-” it preferably is 1, 2, 3 or 4, preferably 2 or 4, m preferably is 1, 2, 3, 4 or 5, in the combination “—Om” it preferably is 1, 2, 3 or 4, more preferably 2 or 4. The combination “-IVm” preferably is “2V1”.)

TABLE D
Exemplary, preferred dielectrically positive compounds

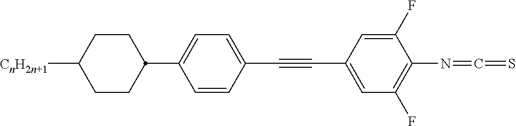

CPTU-n-S

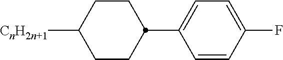

CP-n-F

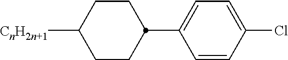

CP-n-CL

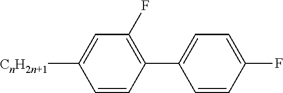

GP-n-F

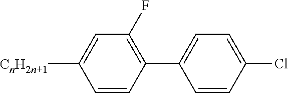

GP-n-CL

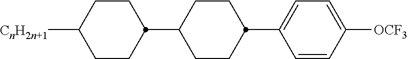

CCP-n-OT

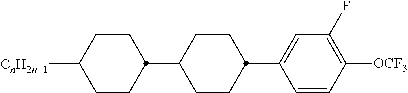

CCG-n-OT

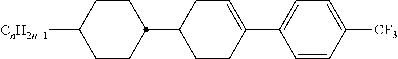

CLP-n-T

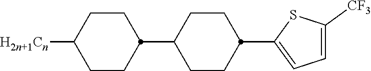

CCS-n-T

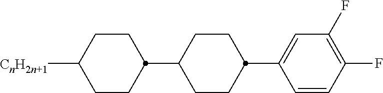

CCG-n-F

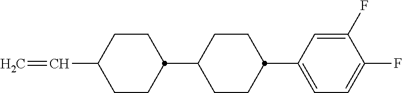

CCG-V-F

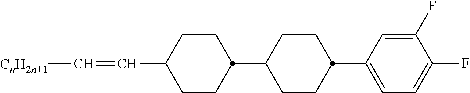

CCG-nV-F

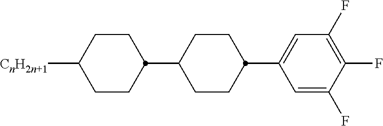

CCU-n-F

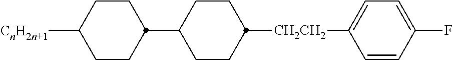

CCEP-n-F

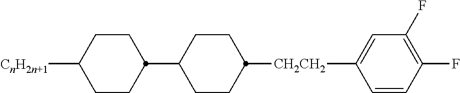

CCEU-n-F

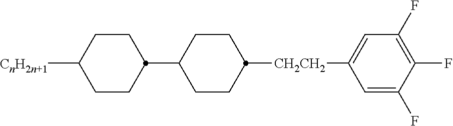

CCEU-n-F

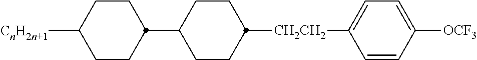

CCEP-n-OT

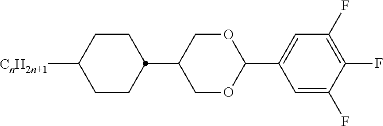

CDU-n-F

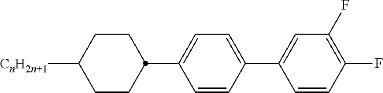

CPG-n-F

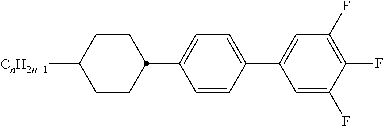

CPU-n-F

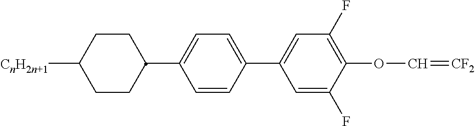

CPU-n-OXF

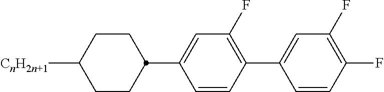

CGG-n-F

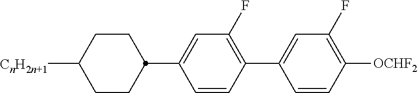

CGG-n-OD

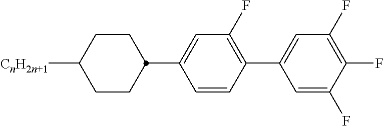

CGU-n-F

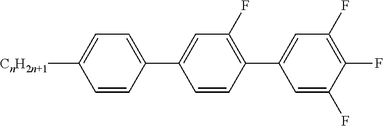

PGU-n-F

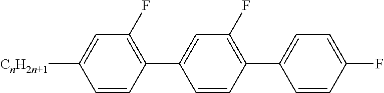

GGP-n-F

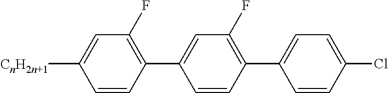

GGP-n-CL

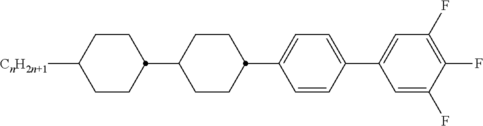

CCPU-n-F

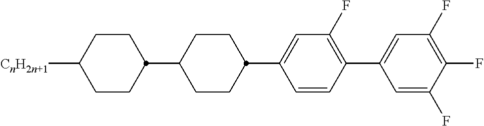

CCGU-n-F

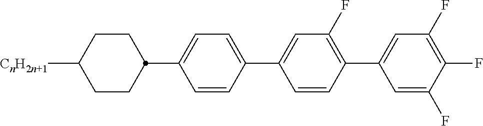

CPGU-n-F

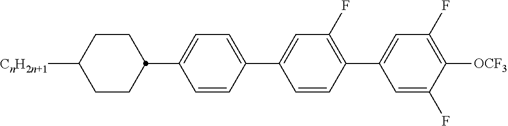

CPGU-n-OT

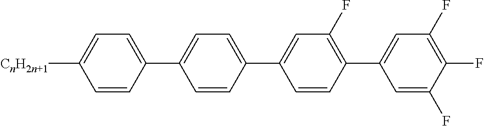

PPGU-n-F

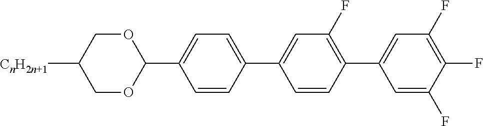

DPGU-n-F

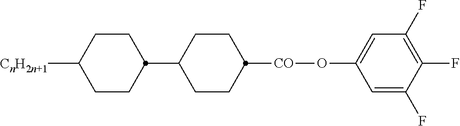

CCZU-n-F

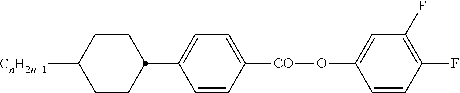

CPZG-n-N

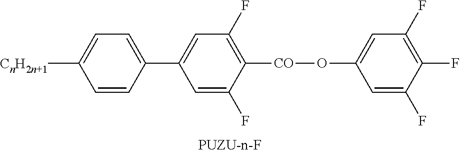

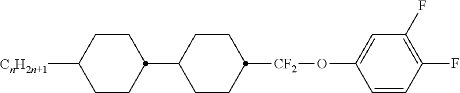

CCQG-n-F

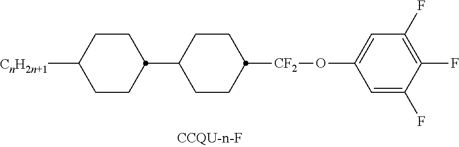

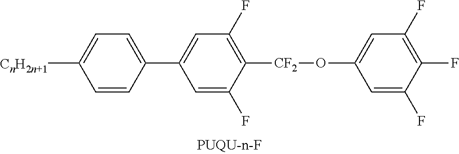

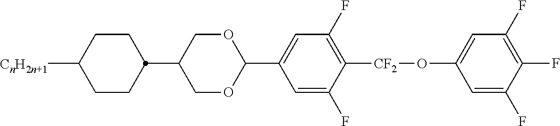

CDUQU-n-F

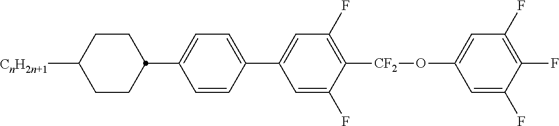

CPUQU-n-F

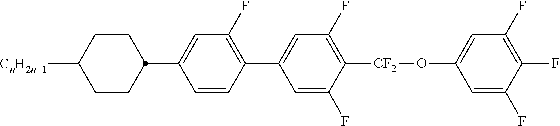

CGUQU-n-F

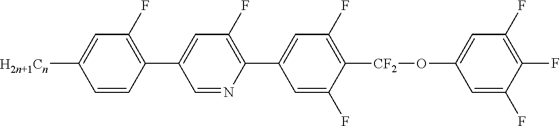

GnfUQU-n-F

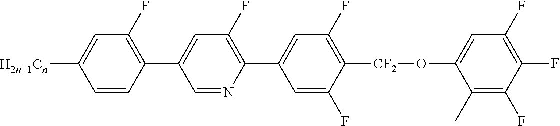

GnfUQU(Me)-n-F

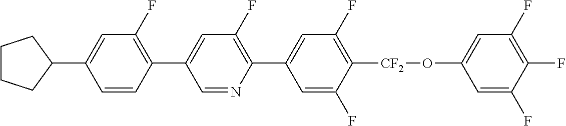

GnfUQU-cp-F

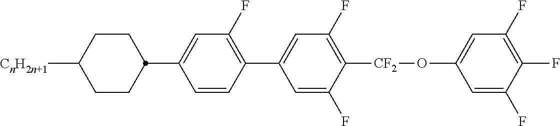

PGUQU-n-F

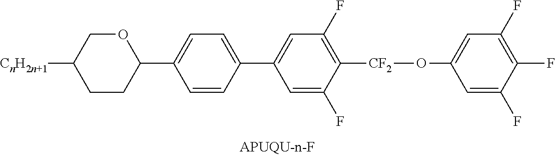

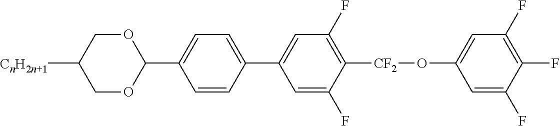

DPUQU-n-F

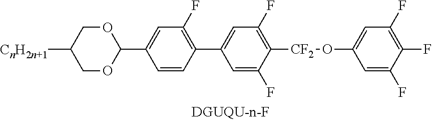

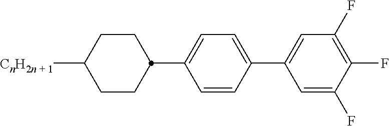

CPU-n-F

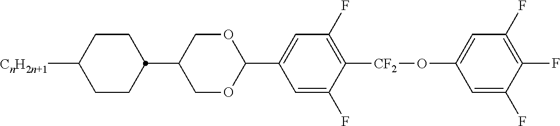

DAUQU-n-F

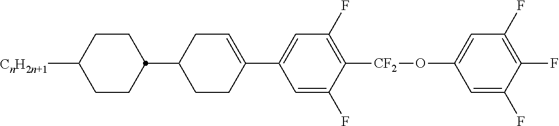

CLUQU-n-F

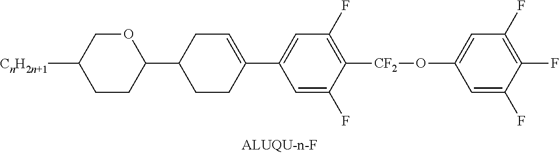

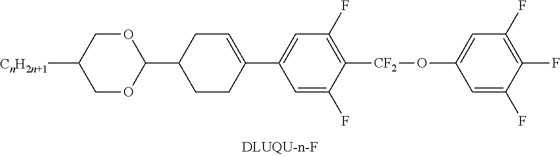

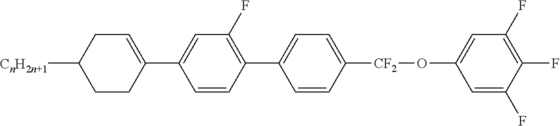

LGPQU-n-F

Exemplary, preferred dielectrically neutral compounds

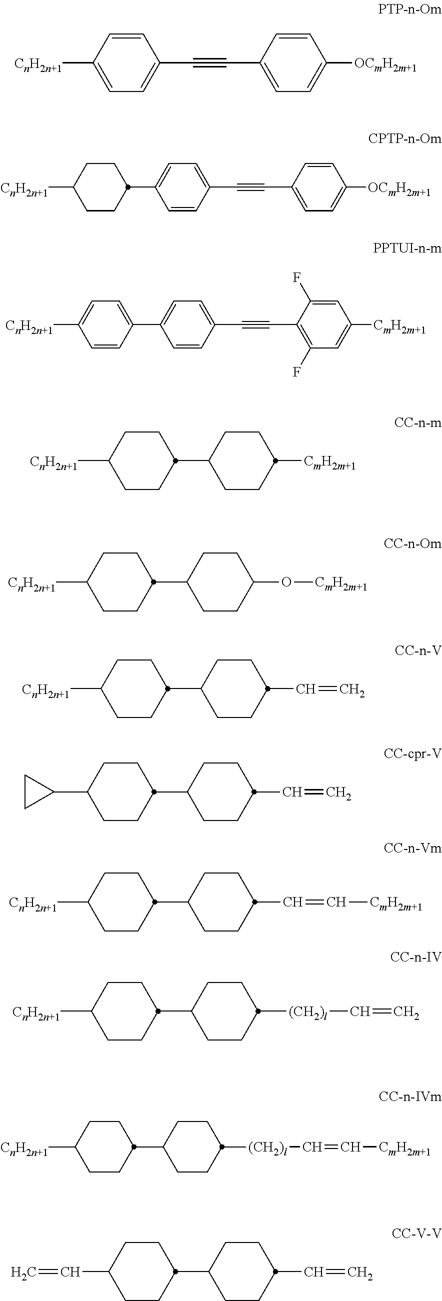

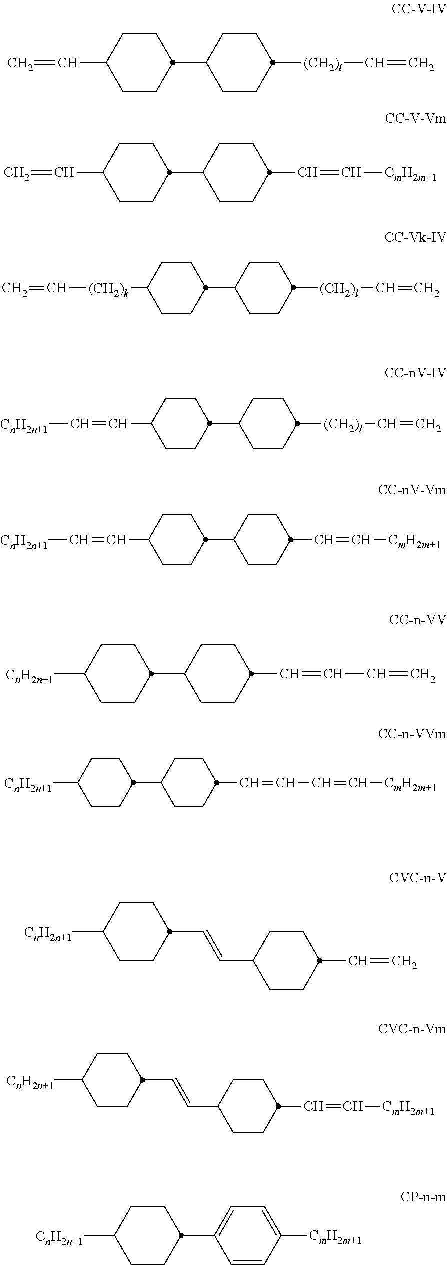

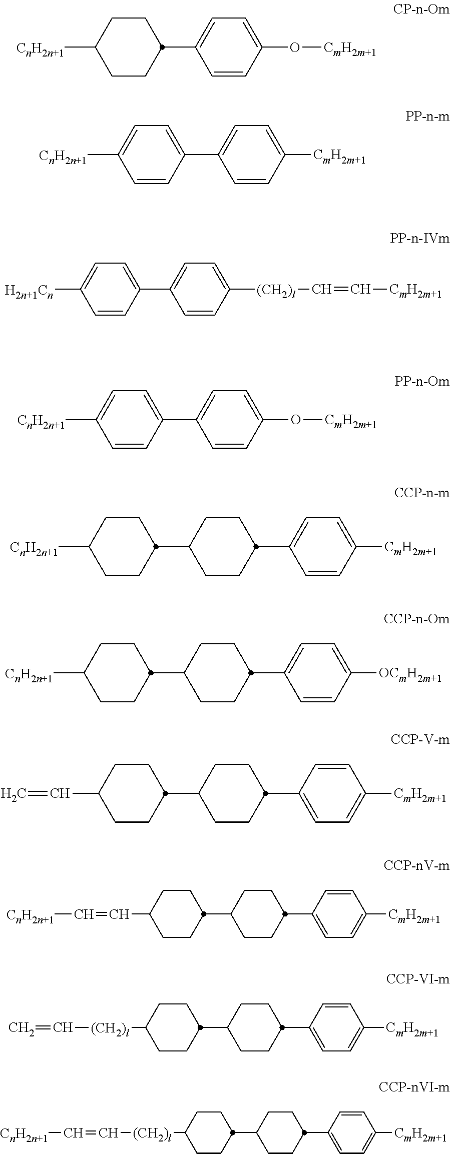

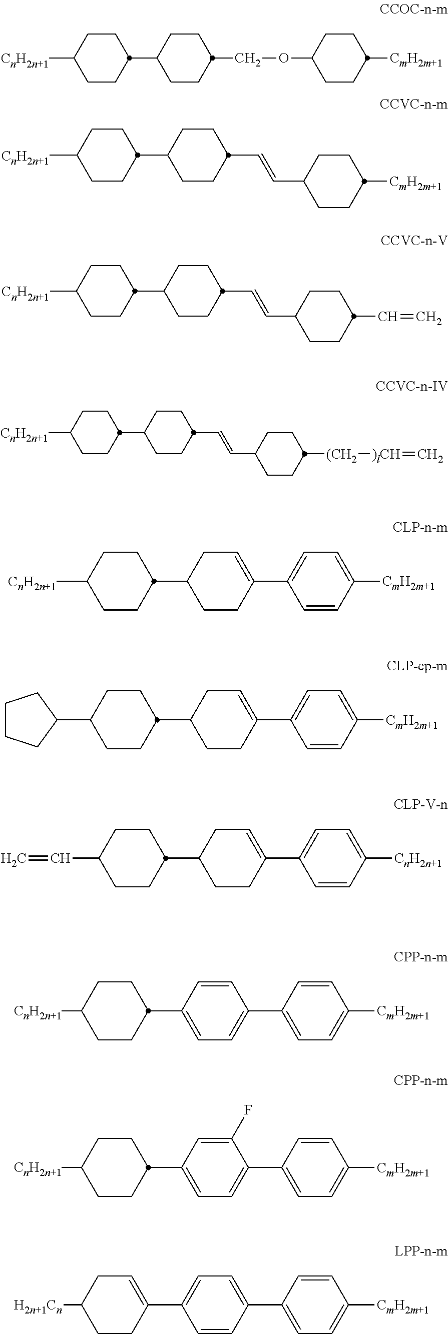

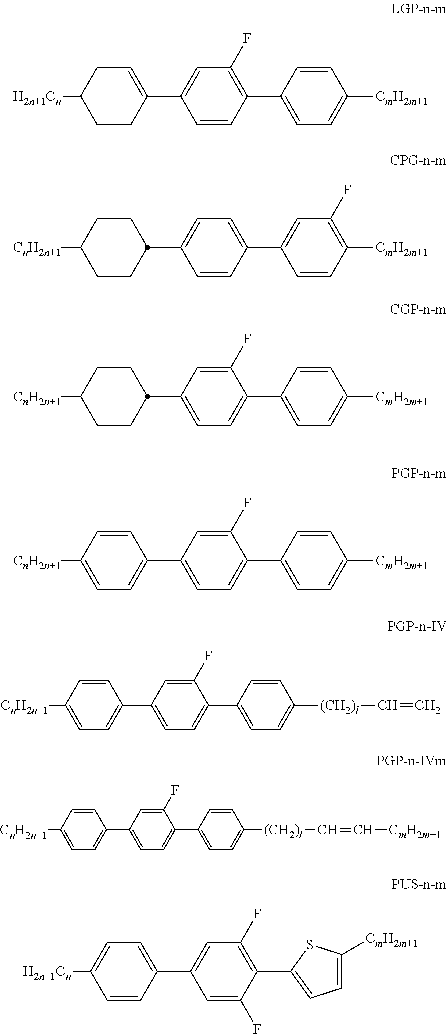

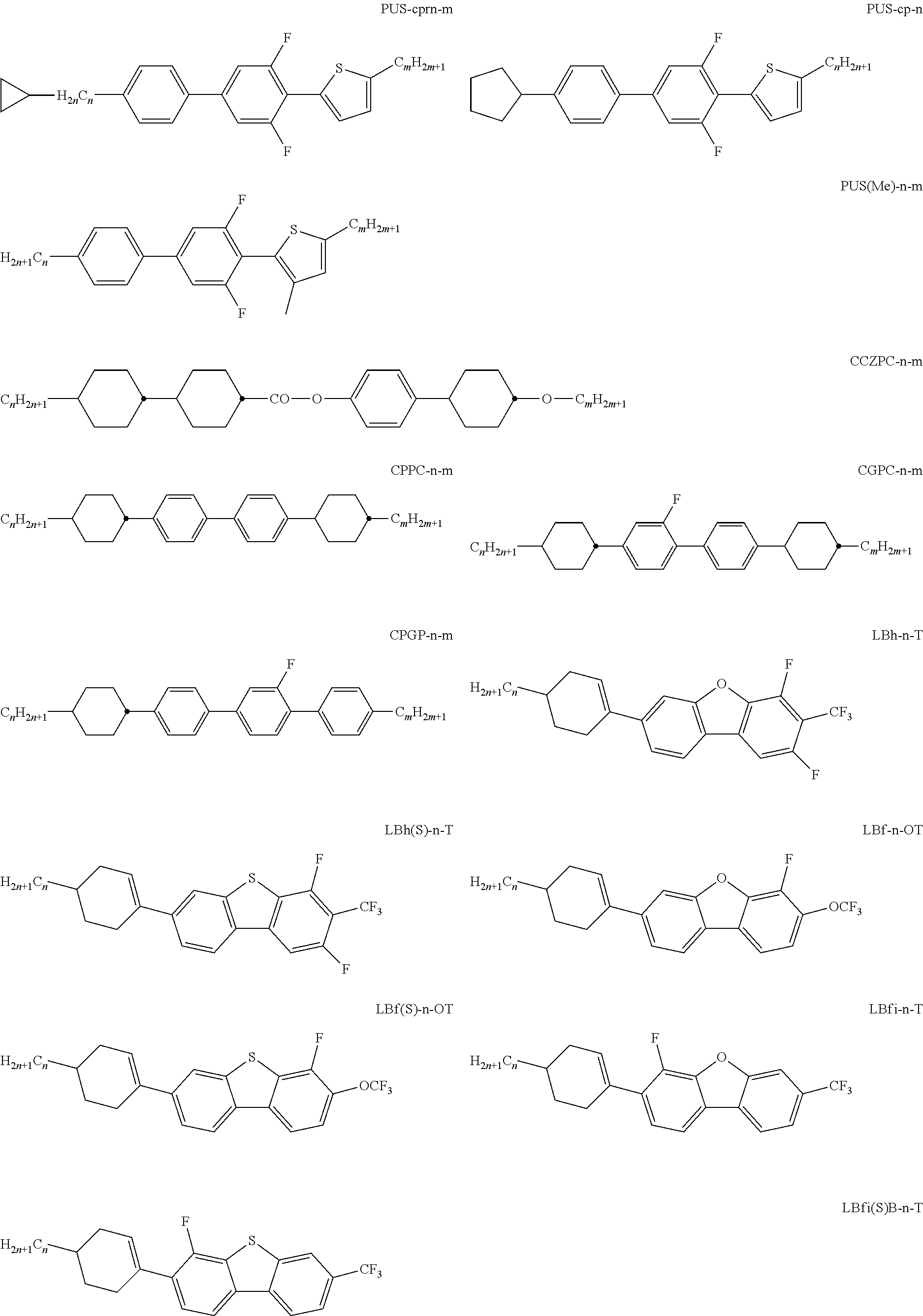

Exemplary, preferred dielectrically negative compounds

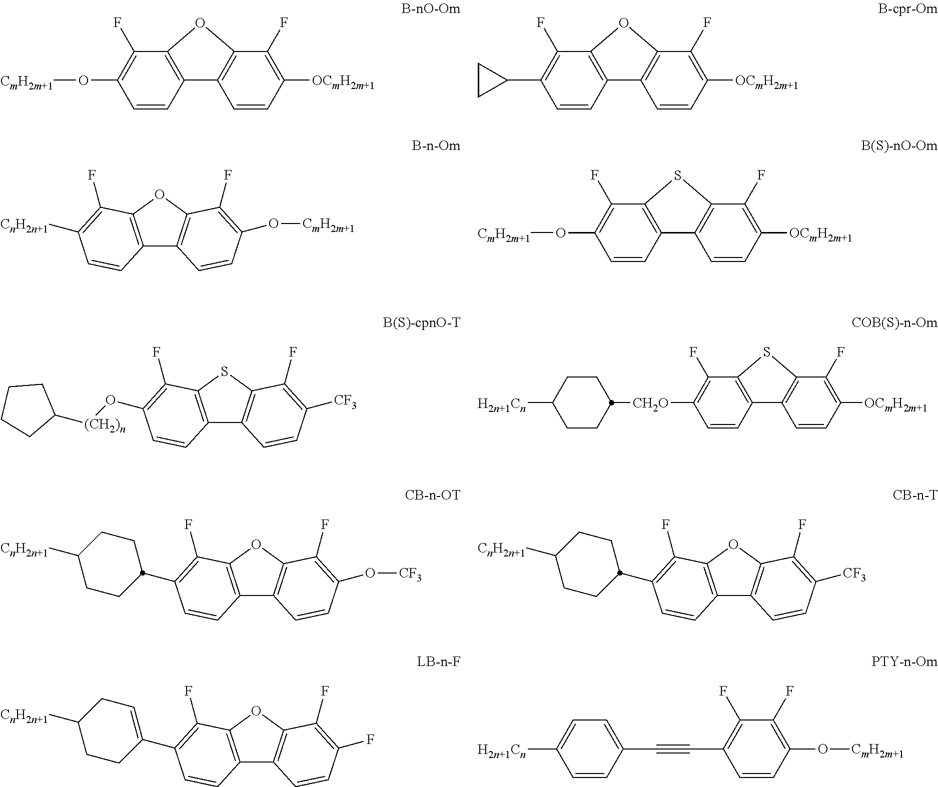

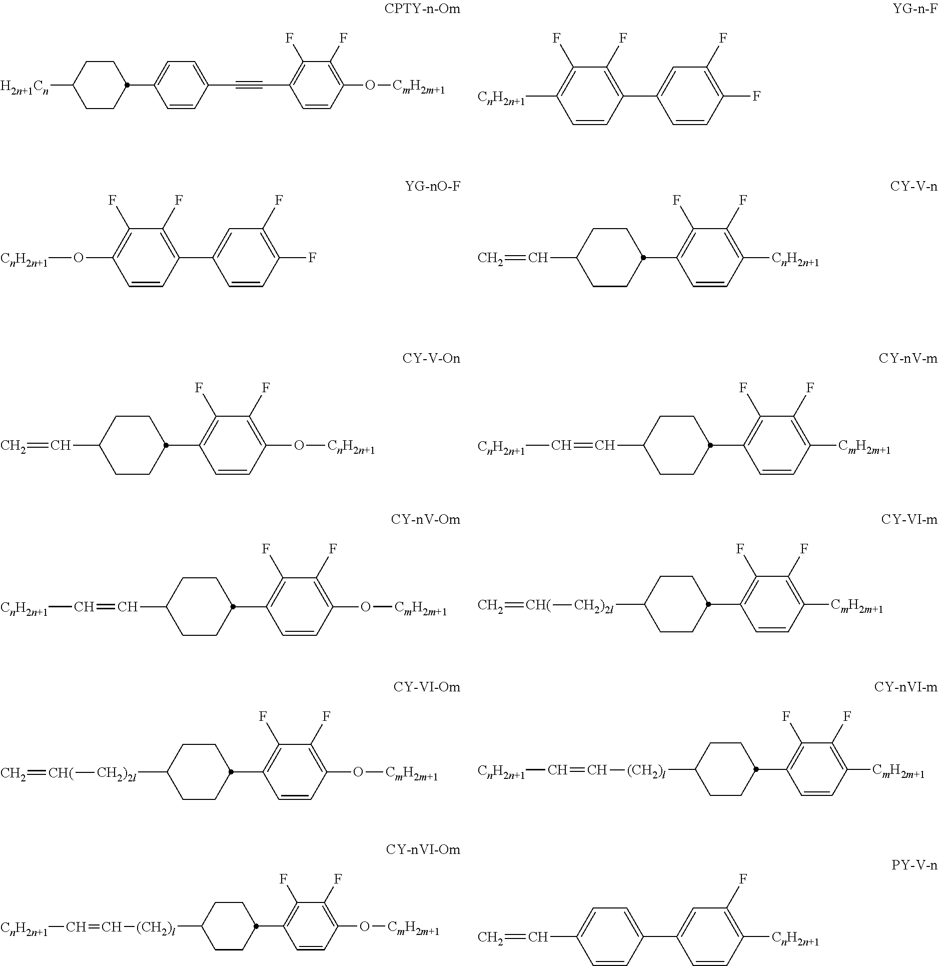

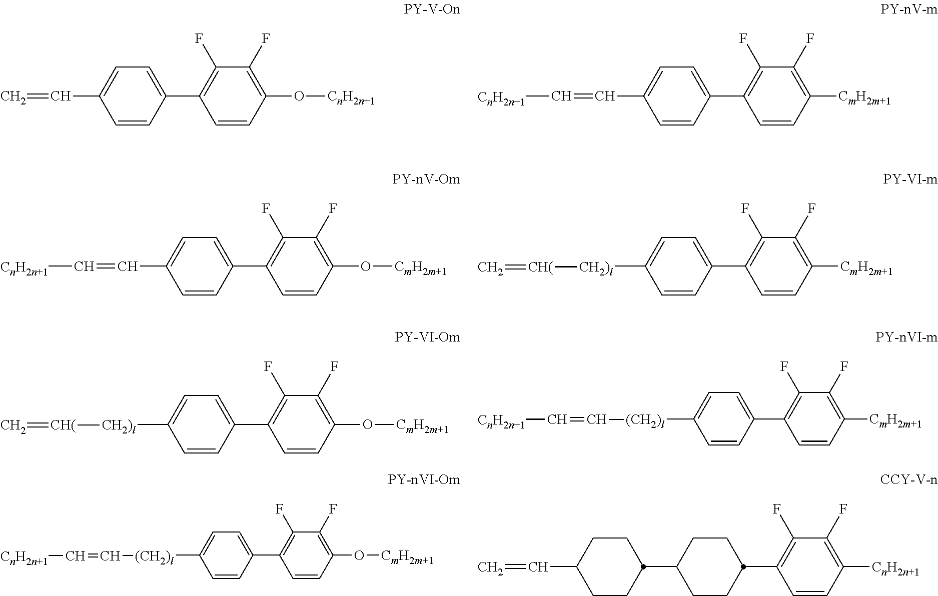

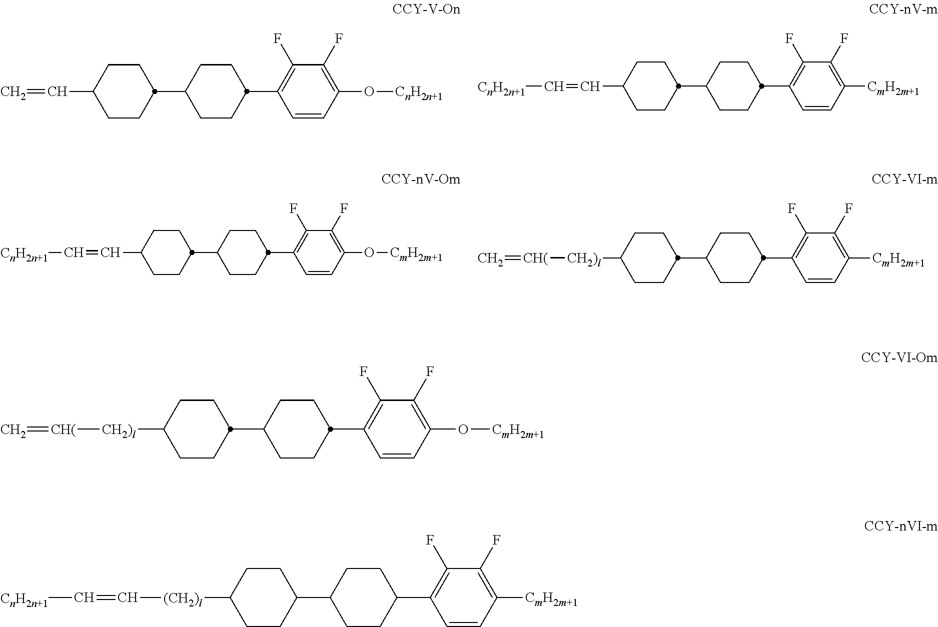

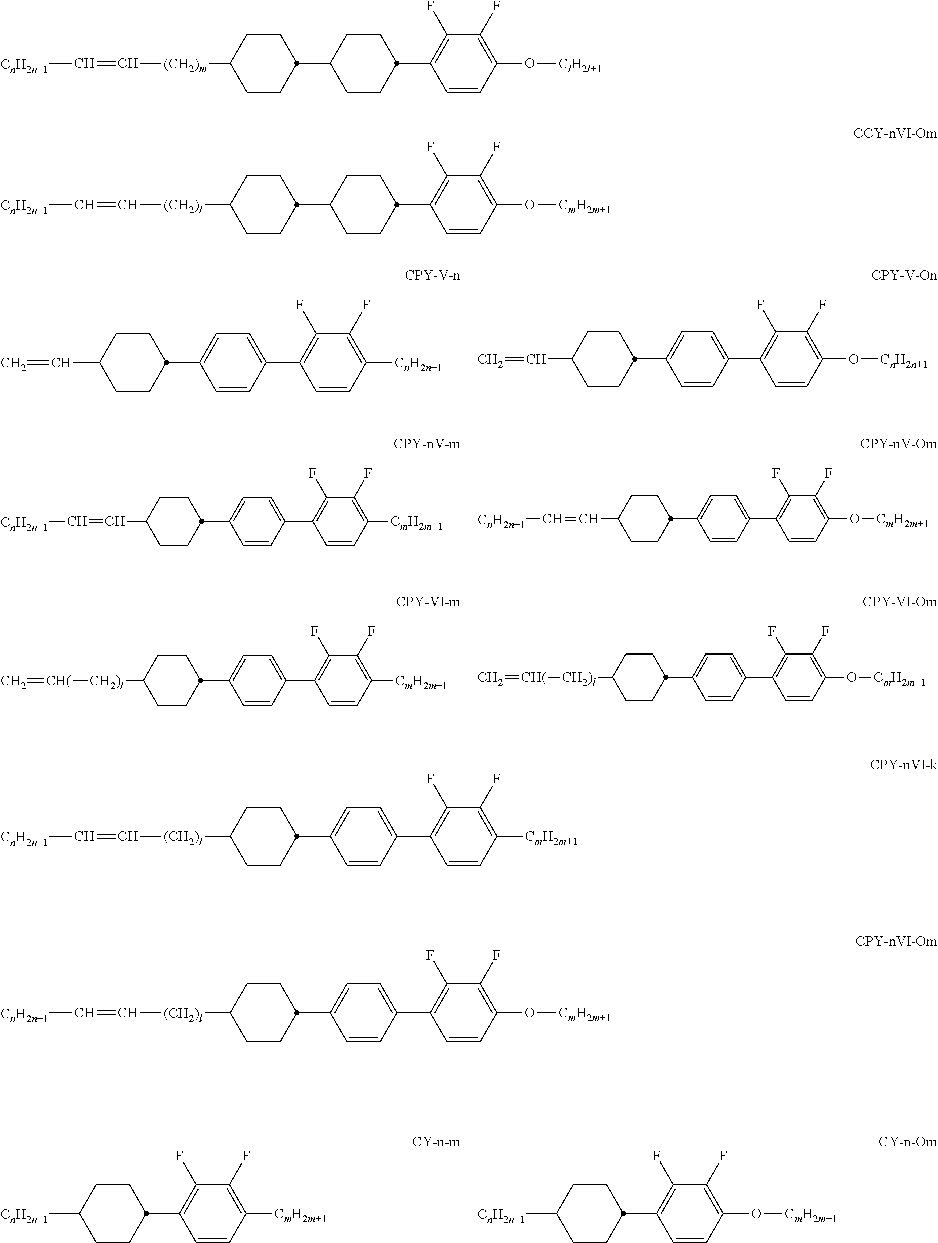

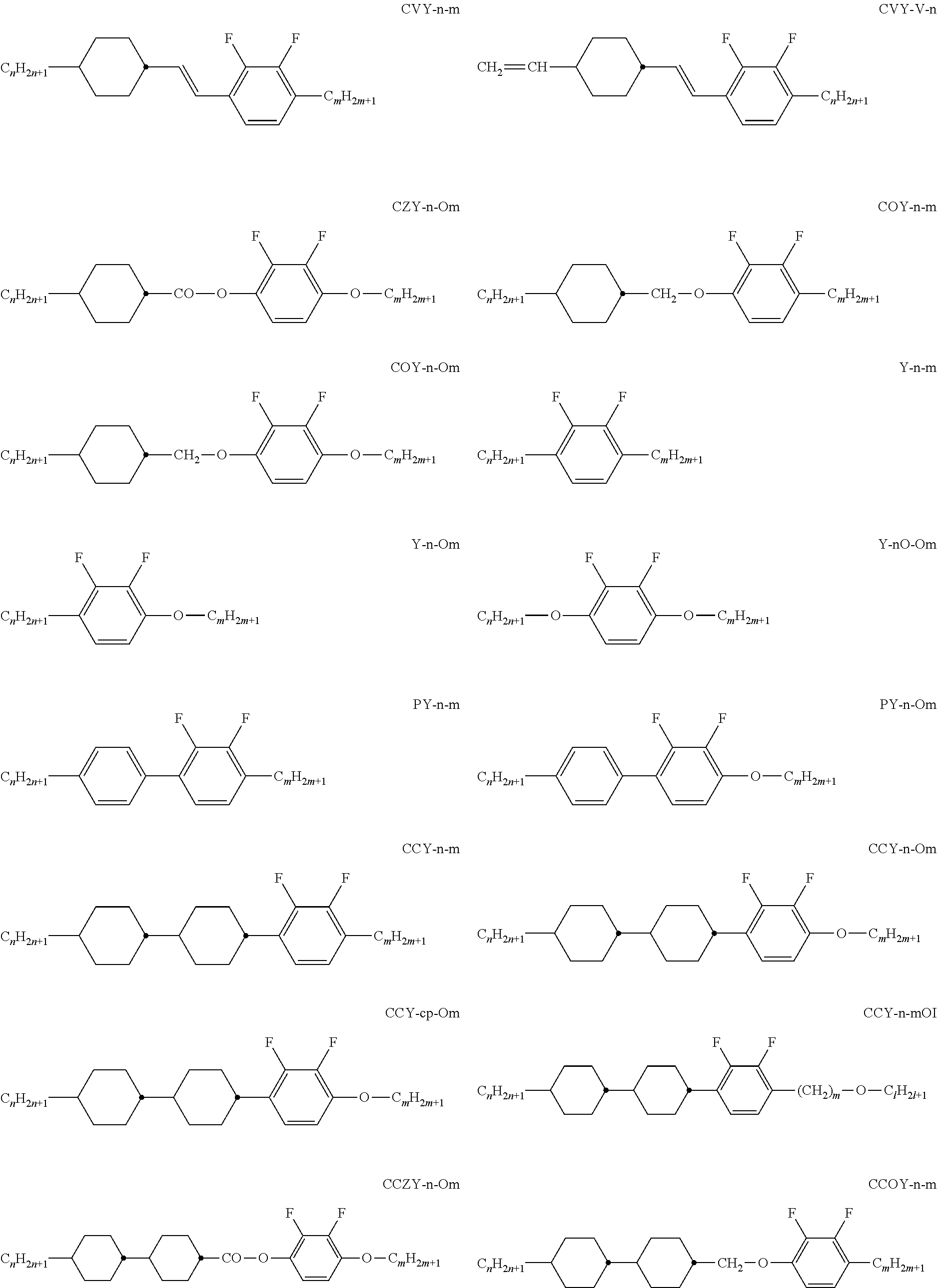

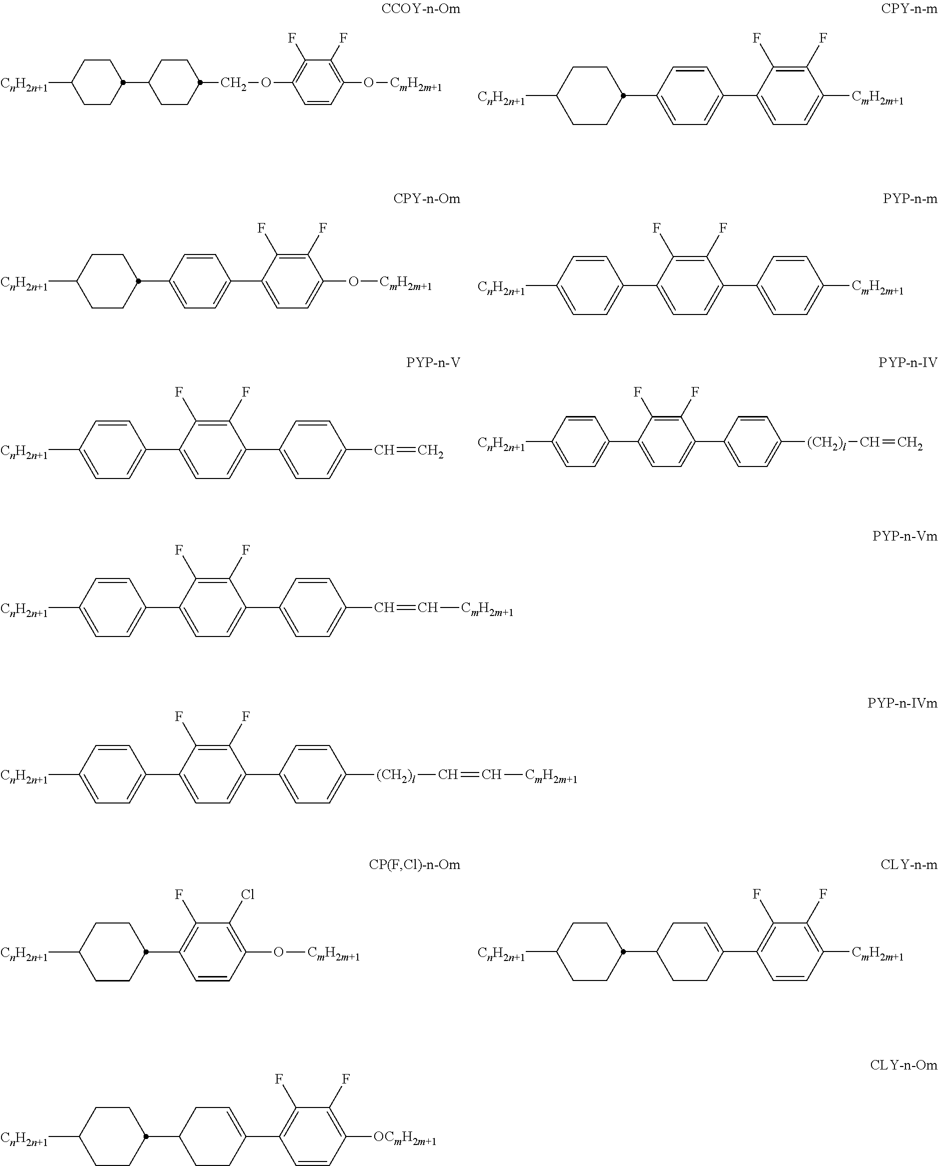

Table E shows chiral dopants which are preferably employed in the mixtures according to the invention.

TABLE E

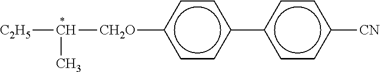

C 15

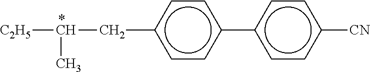

CB 15

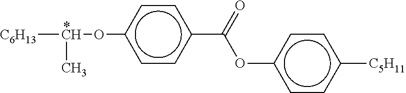

CM 21

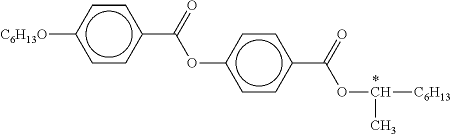

R S-811 / S-811

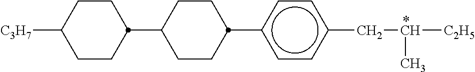

CM 44

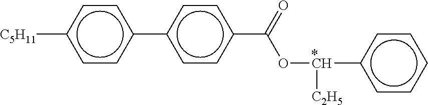

CM 45

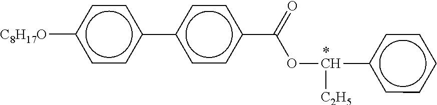

CM 47

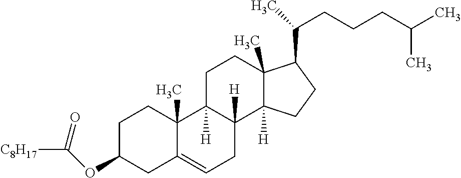

CN

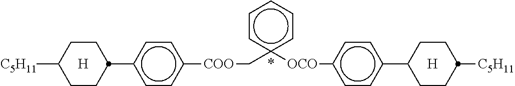

R-1011 / S-1011

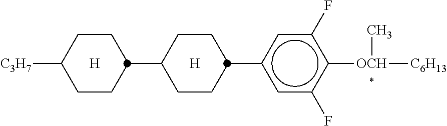

R-2011 / S-2011

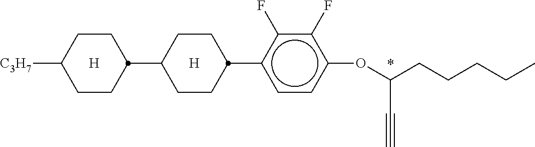

R-3011 / S-3011

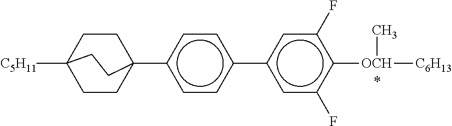

R-4011 / S-4011

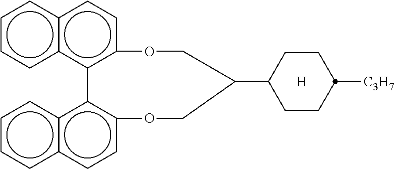

R-5011 / S-5011

In a preferred embodiment of the present invention, the media according to the invention comprise one or more compounds selected from the group of the compounds from Table E.

Table F shows stabilisers which can preferably be employed in addition in the mixtures according to the invention. The parameter n here denotes an integer in the range from 1 to 12. In particular, the phenol derivatives shown can be employed as additional stabilisers since they act as antioxidants.

TABLE F

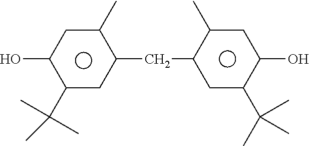 [SMILES: CC1CC(O)C(C(C)(C)C)CC1CC1CC(C(C)(C)C)C(O)CC1C]

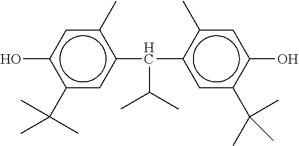

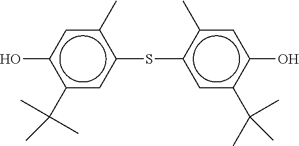

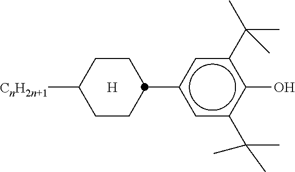

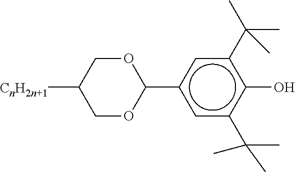

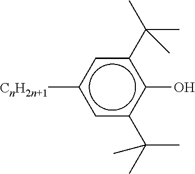

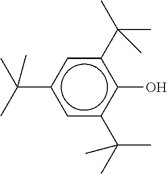

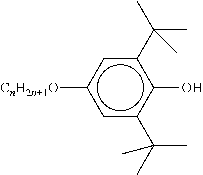

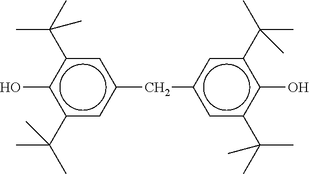

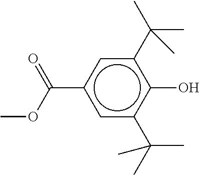

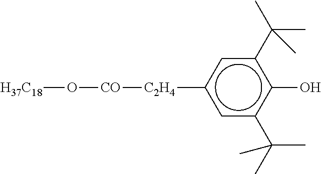

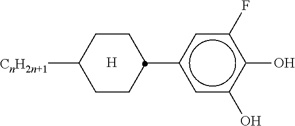

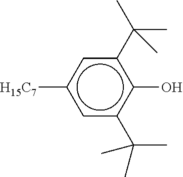

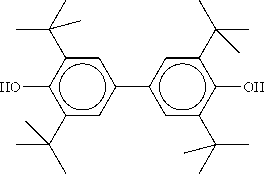

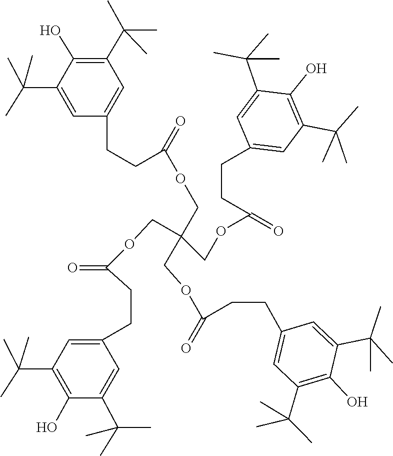 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

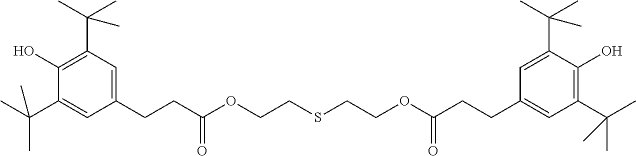 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

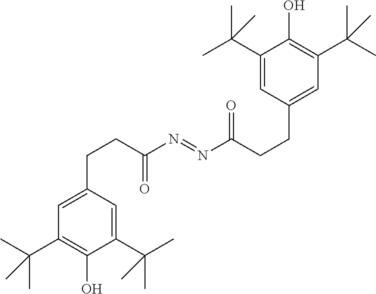 [SMILES: CC(C)(C)c1cc(CCC(=O)/N=N/C(=O)CCc2cc(C(C)(C)C)c(O)c(C(C)(C)C)c2)cc(C(C)(C)C)c1O]

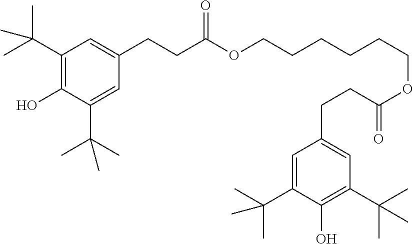 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

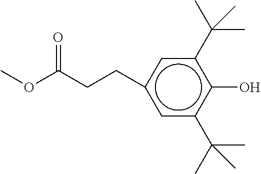

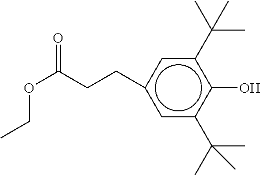

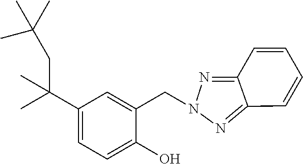 [SMILES: CC(C)(C)CC(C)(C)c1ccc(O)c(Cn2nc3ccccc3n2)c1]

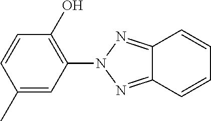 [SMILES: Cc1ccc(O)c(-n2nc3ccccc3n2)c1]

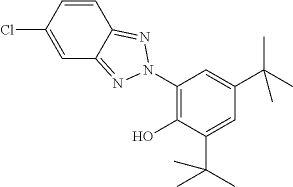 [SMILES: CC(C)(C)c1cc(-n2nc3ccc(Cl)cc3n2)c(O)c(C(C)(C)C)c1]

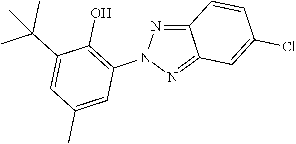 [SMILES: Cc1cc(-n2nc3ccc(Cl)cc3n2)c(O)c(C(C)(C)C)c1]

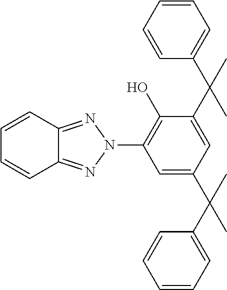 [SMILES: CC(C)(c1ccccc1)c1cc(-n2nc3ccccc3n2)c(O)c(C(C)(C)c2ccccc2)c1]

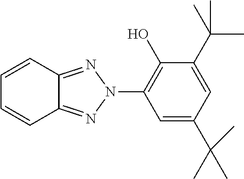 [SMILES: CC(C)(C)c1cc(-n2nc3ccccc3n2)c(O)c(C(C)(C)C)c1]

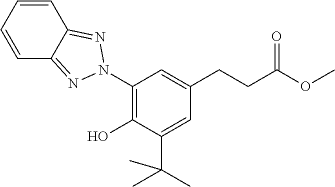 [SMILES: COC(=O)CCc1cc(-n2nc3ccccc3n2)c(O)c(C(C)(C)C)c1]

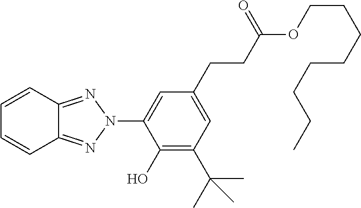 [SMILES: CCCCCCCCOC(=O)CCc1cc(-n2nc3ccccc3n2)c(O)c(C(C)(C)C)c1]

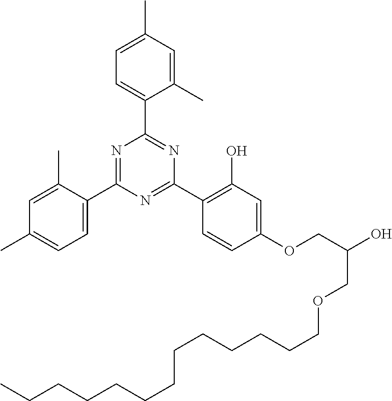 [SMILES: CCCCCCCCCCCCCOCC(O)COc1ccc(-c2nc(-c3ccc(C)cc3C)nc(-c3ccc(C)cc3C)n2)c(O)c1]

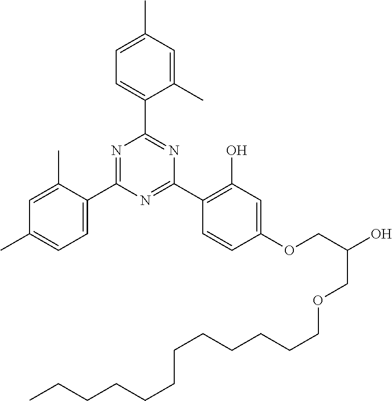 [SMILES: CCCCCCCCCCCCOCC(O)COc1ccc(-c2nc(-c3ccc(C)cc3C)nc(-c3ccc(C)cc3C)n2)c(O)c1]

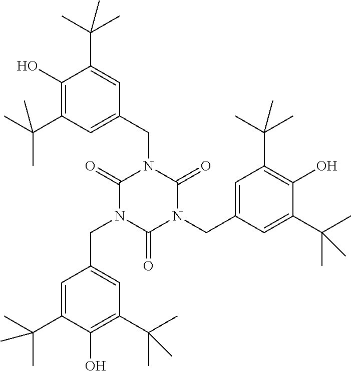 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

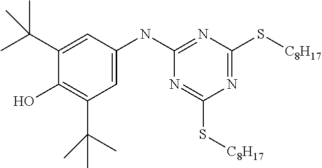

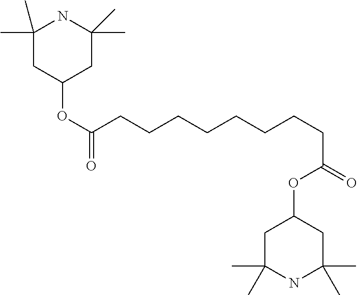

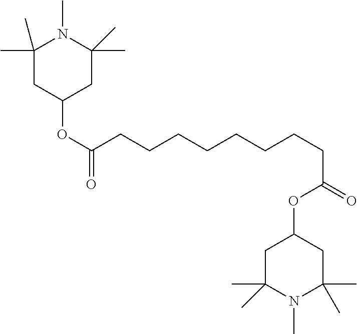

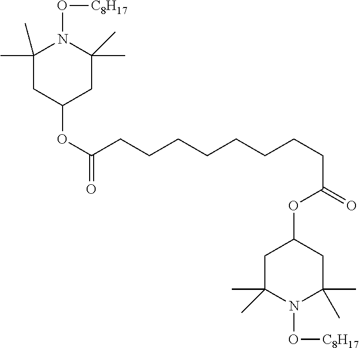

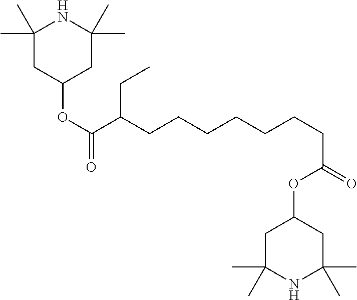

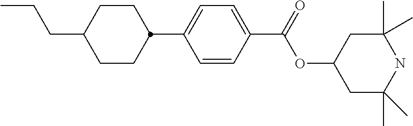

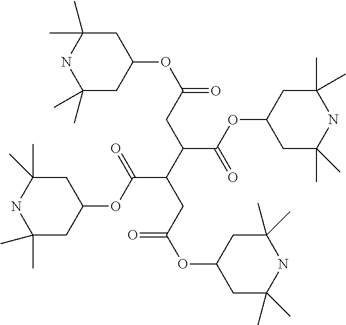

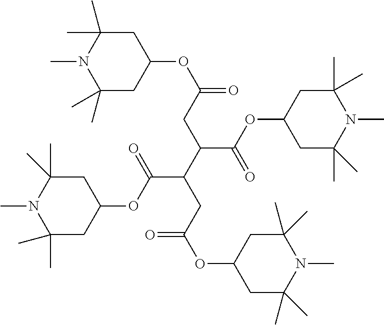

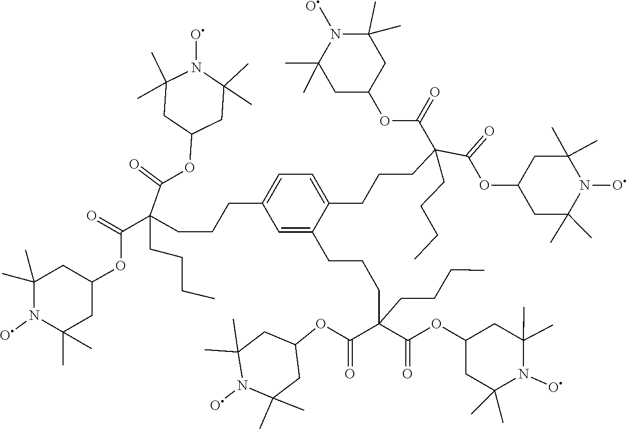

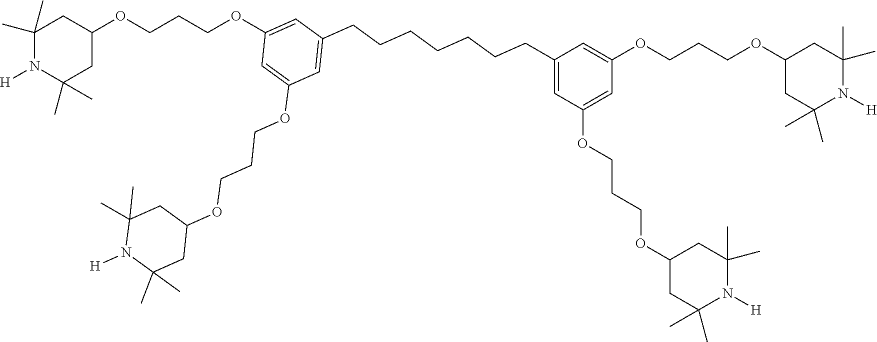

In a preferred embodiment of the present invention, the media according to the invention comprise one or more compounds selected from the group of the compounds from Table F, in particular one or more compounds selected from the group of the compounds of the following two formulae

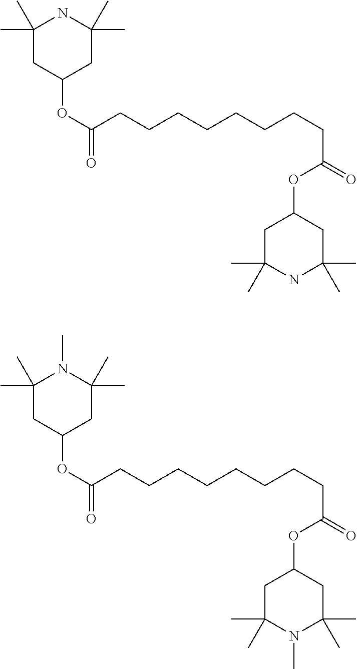

### EXAMPLES

The following examples explain the present invention without restricting it in any way. However, the physical properties make it clear to the person skilled in the art what properties can be achieved and in what ranges they can be modified. In particular, the combination of the various properties which can preferably be achieved is thus well defined for the person skilled in the art.

### MIXTURE EXAMPLES

In the following exemplary mixtures are disclosed. AII %-values are % by weight.

The following mixtures are prepared and investigated.

Mixture Example 1

| | | | |
|---|---|---|---|
| CPTU-5-S | 22.0 | T(N, I) [° C.]: | 136.5 |
| PPTU-5-S | 10.0 | nₑ [589 nm, 20° C.]: | 1.8141 |
| B(S)-2O-O4 | 5.0 | nₒ [589 nm, 20° C.]: | 1.5076 |
| B(S)-2O-O5 | 5.0 | Δn [589 nm, 20° C.]: | 0.3065 |
| B(S)-2O-O6 | 5.0 | ε_{∥} [1 kHz, 20° C.]: | 10.6 |
| PTY-5-O2 | 13.0 | ε_{⊥} [1 kHz, 20° C.]: | 8.2 |
| CPTY-3-O2 | 12.0 | Δε [1 kHz, 20° C.]: | 2.4 |
| CPTY-5-O2 | 10.0 | K₁ [pN, 20° C.]: | 24.4 |
| PTP-3-O1 | 8.0 | K₃ [pN, 20° C.]: | 28.2 |
| CP-3-O2 | 10.0 | K₃/K₁ [pN, 20° C.]: | 1.15 |
| Σ | 100.0 | V₀ [V, 20° C.]: | 3.40 |

The crossover frequency f_{CO} of this mixture is 4.0 kHz.

### Mixture Examples 1.1

0.03% of the compound of the formula

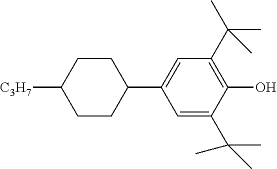

is added to the mixture M-1. The resultant mixture M-1.1 is characterized by an improved stability against severe conditions, especially against exposure to light.

### Mixture Examples 1.2

0.4% of the compound of the formula

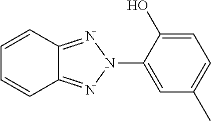 [SMILES: Cc1ccc(O)c(-n2nc3ccccc3n2)c1]

is added to the mixture M-1. The resultant mixture M-1.2 is characterized by an improved stability against severe conditions, especially against exposure to light.

### Mixture Examples 1.3

0.05% of the compound of the formula

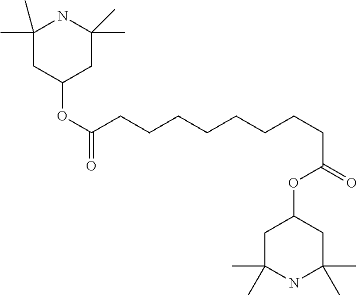

is added to the mixture M-1. The resultant mixture M-1.3 is characterized by an improved stability against severe conditions, especially against exposure to light.

Alternatively, 0.05% of the compounds of one of the formulae

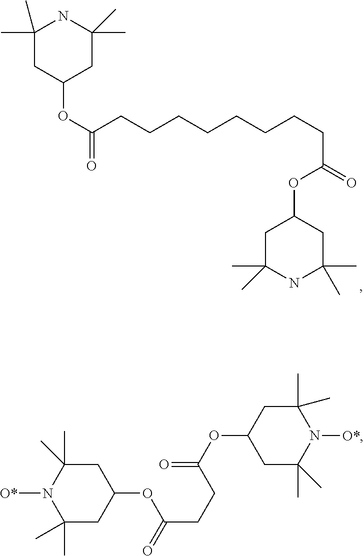

wherein the two a atoms bonded to the N atoms indicate radicals, or

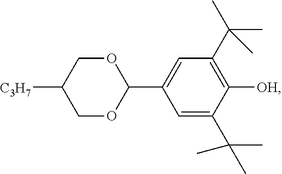

can be added to the mixture M-1 for the purpose of stabilization.

Comparative Mixture Example 1

| Compound | weight % | Physical properties | |
|---|---|---|---|
| CPZG-5-N | 14.0 | T(N, I) [° C.]: | 106.2 |
| PTY-3-O2 | 10.0 | nₑ [589 nm, 20° C.]: | 1.7192 |
| PTY-5-O2 | 13.0 | nₒ [589 nm, 20° C.]: | 1.4978 |
| CPTY-3-O2 | 12.0 | Δn [589 nm, 20° C.]: | 0.2214 |
| CPTY-5-O2 | 16.0 | ε_{∥} [1 kHz, 20° C.]: | 10.6 |
| PTP-3-O1 | 6.0 | ε_{⊥} [1 kHz, 20° C.]: | 7.3 |
| PTP-5-O1 | 5.0 | Δε [1 kHz, 20° C.]: | 3.2 |
| CP-3-O1 | 16.0 | K₁ [pN, 20° C.]: | 16.1 |
| CP-3-O2 | 8.0 | K₃ [pN, 20° C.]: | 22.4 |
| Σ | 100.0 | K₃/K₁ [pN, 20° C.]: | 1.39 |
| | | V₀ [V, 20° C.]: | 2.40 |

The crossover frequency f_{CO} of this mixture is 12.5 kHz.

Mixture Example 2

| Compound | weight % | Physical properties | |
|---|---|---|---|
| CPZG-5-N | 14.0 | T(N, I) [° C.]: | 115 |
| B(S)-2O-O4 | 5.0 | nₑ [589 nm, 20° C.]: | 1.7254 |
| B(S)-2O-O5 | 5.0 | nₒ [589 nm, 20° C.]: | 1.5008 |
| B(S)-2O-O6 | 5.0 | Δn [589 nm, 20° C.]: | 0.2246 |
| PTY-5-O2 | 13.0 | ε_{∥} [1 kHz, 20° C.]: | 11.9 |
| CPTY-3-O2 | 12.0 | ε_{⊥} [1 kHz, 20° C.]: | 8.8 |
| CPTY-5-O2 | 10.0 | Δε [1 kHz, 20° C.]: | 3.0 |
| PPTUI-3-2 | 12.0 | K₁ [pN, 20° C.]: | 17.5 |
| CP-3-O1 | 16.0 | K₃ [pN, 20° C.]: | 22.3 |
| CP-3-O2 | 8.0 | K₃/K₁ [pN, 20° C.]: | 1.27 |
| Σ | 100.0 | V₀ [V, 20° C.]: | 2.55 |

The crossover frequency f_{CO} of this mixture is 6.0 kHz.

Mixture Example 3

| Compound | weight % | Physical properties | |
|---|---|---|---|
| CPZG-5-N | 14.0 | T(N, I) [° C.]: | 99.5 |
| B(S)-2O-O4 | 5.0 | nₑ [589 nm, 20° C.]: | 1.7161 |
| B(S)-2O-O5 | 5.0 | nₒ [589 nm, 20° C.]: | 1.5028 |
| B(S)-2O-O6 | 5.0 | Δn [589 nm, 20° C.]: | 0.2133 |
| PTY-5-O2 | 13.0 | ε_{∥} [1 kHz, 20° C.]: | 11.4 |
| CPTY-3-O2 | 12.0 | ε_{⊥} [1 kHz, 20° C.]: | 8.8 |
| CPTY-5-O2 | 10.0 | Δε [1 kHz, 20° C.]: | 2.6 |
| PTP-3-O1 | 7.0 | γ₁ [mPa s, 20° C.]: | 238 |
| PTP-2-O1 | 5.0 | K₁ [pN, 20° C.]: | 15.6 |
| CP-3-O1 | 16.0 | K₃ [pN, 20° C.]: | 20.5 |
| CP-3-O2 | 8.0 | K₃/K₁ [pN, 20° C.]: | 1.31 |
| Σ | 100.0 | V₀ [V, 20° C.]: | 2.59 |

The crossover frequency f_{CO} of this mixture is 10 kHz.

Mixture Example 4

| Compound | weight % | Physical properties | |
|---|---|---|---|
| CPZG-5-N | 14.0 | T(N, I) [° C.]: | 102.5 |
| B(S)-2O-O4 | 8.0 | nₑ [589 nm, 20° C.]: | 1.7276 |
| B(S)-2O-O5 | 8.0 | nₒ [589 nm, 20° C.]: | 1.5046 |
| B(S)-2O-O6 | 8.0 | Δn [589 nm, 20° C.]: | 0.2230 |
| PTY-5-O2 | 13.0 | ε_{∥} [1 kHz, 20° C.]: | 12.5 |
| CPTY-3-O2 | 12.0 | ε_{⊥} [1 kHz, 20° C.]: | 9.9 |
| PPTUI-3-2 | 14.0 | Δε [1 kHz, 20° C.]: | 2.6 |
| CP-3-O1 | 15.0 | K₁ [pN, 20° C.]: | 16.5 |
| CP-3-O2 | 8.0 | K₃ [pN, 20° C.]: | 20.8 |
| Σ | 100.0 | K₃/K₁ [pN, 20° C.]: | 1.26 |
| | | V₀ [V, 20° C.]: | 2.65 |

The crossover frequency f_{CO} of this mixture is 7.0 kHz.

Mixture Example 5

| Compound | weight % | Physical properties | |
|---|---|---|---|
| CPZG-5-N | 14.0 | T(N, I) [° C.]: | 111 |
| B(S)-2O-O4 | 7.0 | nₑ [589 nm, 20° C.]: | 1.7318 |
| B(S)-2O-O5 | 8.0 | nₒ [589 nm, 20° C.]: | 1.5034 |
| B(S)-2O-O6 | 5.0 | Δn [589 nm, 20° C.]: | 0.2284 |
| PTY-5-O2 | 13.0 | ε_{∥} [1 kHz, 20° C.]: | 12.2 |
| CPTY-3-O2 | 12.0 | ε_{⊥} [1 kHz, 20° C.]: | 9.5 |
| CPTY-5-O2 | 5.0 | Δε [1 kHz, 20° C.]: | 2.8 |
| PPTUI-3-2 | 14.0 | K₁ [pN, 20° C.]: | 17.3 |
| CP-3-O1 | 14.0 | K₃ [pN, 20° C.]: | 22.1 |
| CP-3-O2 | 8.0 | K₃/K₁ [pN, 20° C.]: | 1.27 |
| Σ | 100.0 | V₀ [V, 20° C.]: | 2.65 |

The crossover frequency f_{CO} of this mixture is 6.0 kHz.

Mixture Example 6

| Compound | weight % | Physical properties | |
|---|---|---|---|
| CPZG-5-N | 15.0 | T(N, I) [° C.]: | 109.5 |
| B(S)-2O-O4 | 6.0 | nₑ [589 nm, 20° C.]: | 1.7273 |
| B(S)-2O-O5 | 6.0 | nₒ [589 nm, 20° C.]: | 1.5046 |
| B(S)-2O-O6 | 5.0 | Δn [589 nm, 20° C.]: | 0.2227 |
| COB(S)-2-O4 | 8.0 | ε_{∥} [1 kHz, 20° C.]: | 12.9 |
| PTY-5-O2 | 12.0 | ε_{⊥} [1 kHz, 20° C.]: | 9.6 |
| CPTY-3-O2 | 10.0 | Δε [1 kHz, 20° C.]: | 3.3 |
| PPTUI-3-2 | 16.0 | K₁ [pN, 20° C.]: | 16.9 |
| CP-3-O1 | 14.0 | K₃ [pN, 20° C.]: | 19.6 |
| CP-3-O2 | 8.0 | K₃/K₁ [pN, 20° C.]: | 1.16 |
| Σ | 100.0 | V₀ [V, 20° C.]: | 2.39 |

The crossover frequency f_{CO} of this mixture is 6.0 kHz.

1. A liquid-crystalline medium having a nematic phase, the medium comprising one or more compounds of formula I 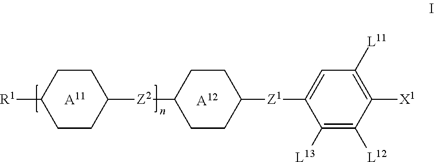
in which
R¹ is an alkyl radical having 1 to 15 C atoms, wherein one or more CH₂ groups, including terminal C atoms, in this radical may each be replaced, independently of one another, by —C≡C—, —CH═CH—, 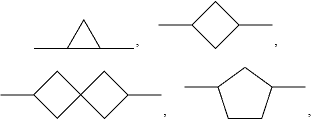
—O—, —S—, —(CO)—O— or —O—(CO)— in such a way that O or S atoms are not linked directly to one another, and in which, in addition, one or more H atoms may be replaced by F or Cl, or H, 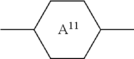
on each appearance, independently of one another, denotes 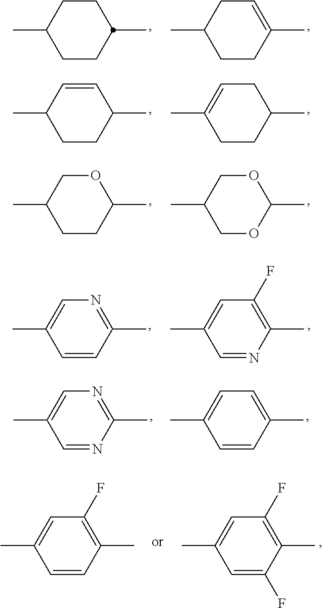 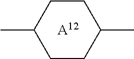
denotes 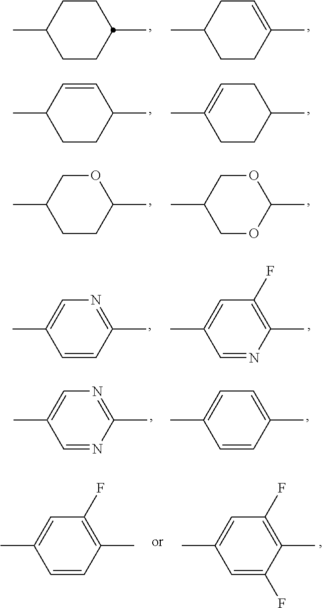
Z¹ denotes —C≡C—, —(CO)O— or —CF₂O—,
Z² denotes a single bond, —(CO)O— or —CF₂O—,
L¹¹, L¹², independently H, F or Cl,
L¹³ H, CH₃ or CH₂CH₃,
X¹—CN, —SCN, —OCF₃ or F,
n denotes 1 or 2,
and one or more additional compounds selected from the group of formulae II, III and VI to IX: 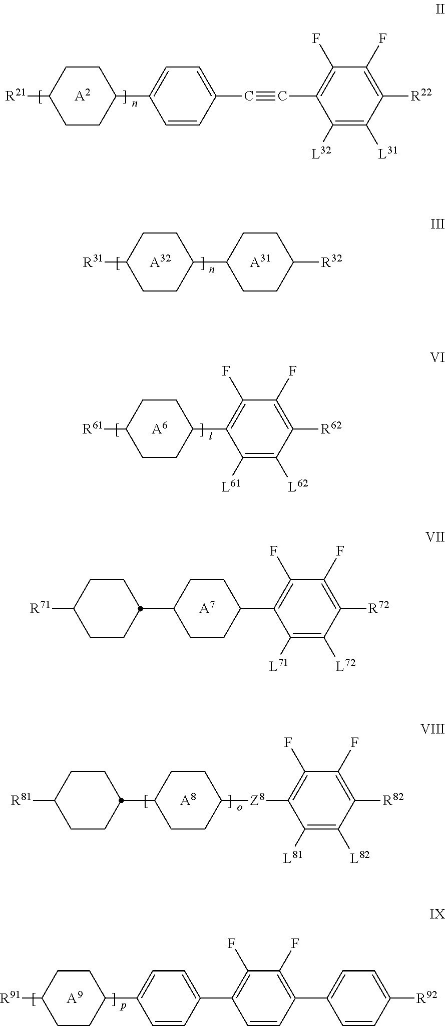
in which
R²¹ and R²² are independently of each other defined as R¹, preferably alkyl or alkoxy with 1 to 7 C-atoms, alkenyl, alkenyloxy or alkoxyalkyl with 2 to 7 C-atoms or C₃₋₅-cycloalkyl-(CH₂)₀₋₁, 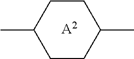
is 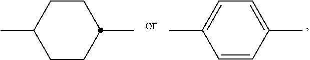
n independently 0 or 1, 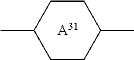
denotes 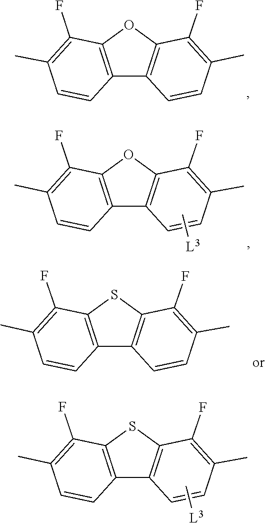
in which
L³ is CH₃, OCH₃ or CH₂CH₃, 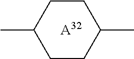
denotes 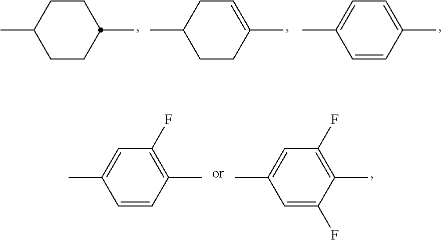
R³¹ and R³² are independently of each other defined as R¹,
R⁶¹ is defined as R¹,
R⁶² is defined as R¹, and
L⁶¹, L⁶² are independently H or methyl,
l denotes 0 or 1,
R⁷¹ is defined as R¹,
R⁷² is defined as R¹, and
L⁷¹, L⁷² independently H or methyl, 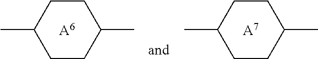
independently denote 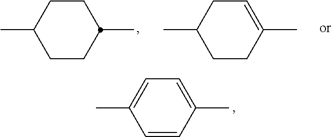
R⁸¹ is defined as R¹,
R⁸² is defined as R¹,
L⁸¹, L⁸² independently H or methyl, 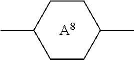
denotes 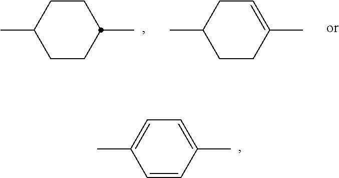
Z⁸ denotes —(CO)—O—, —CH₂—O—, —CF₂—O— or —CH₂—CH₂—,
o denotes 0 or 1,
R⁹¹ and R⁹² independently of one another have the meaning given for R⁷², 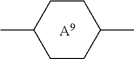
denotes 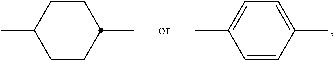
and
p is 0 or 1.

2. The liquid-crystalline medium according to claim 1, comprising one or more compounds of the formula III.

3. The liquid-crystalline medium according to claim 1, comprising one or more compounds of the formula II.

4. The liquid-crystalline medium according to claim 1, further comprising one or more dielectrically neutral compounds selected from the group of formulae IV and V: 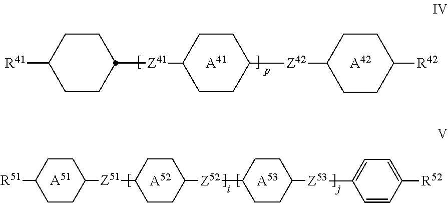
in which
R⁴¹ and R⁴² are independently of one another, an alkyl radical having 1 to 15 C atoms, wherein one or more CH₂ groups, including terminal C atoms, in this radical may each be replaced, independently of one another, by —C≡C—, —CH═CH—, 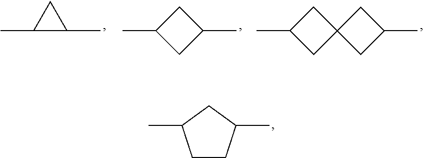
—O—, —S—,
—(CO)—O—, —O—(CO)— in such a way that O or S atoms are not linked directly to one another, and in which, in addition, one or more H atoms may be replaced by F or Cl, 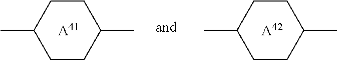
independently of one another and, if 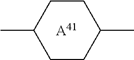
occurs twice,
also these independently of one another, denote 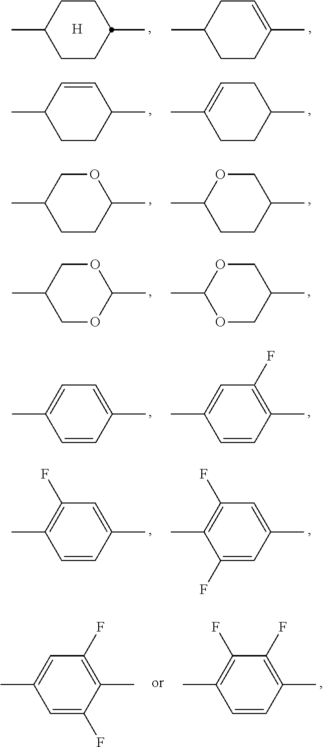
Z⁴¹ and Z⁴² are independently of one another and, if Z⁴¹ occurs twice, also these independently of one another, denote —CH₂CH₂—, —COO—, trans-CH═CH—, trans-CF═CF—, —CH₂O—, —CF₂O—, —C≡C— or a single bond,
p denotes 0, 1 or 2,
R⁵¹ and R⁵², independently of one another, are defined as R⁴¹ and R⁴² 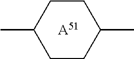
to 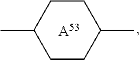
if present, each, independently of one another, denote 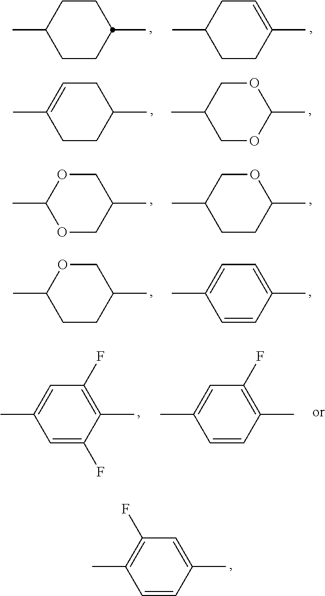
Z⁵¹ to Z⁵³ each, independently of one another, denote
—CH₂—CH₂—, —CH₂—O—, —CH═CH—, —C≡C—, —COO— or a single bond, and
i and j each, independently of one another, denote 0 or 1,
wherein the respective rings optionally may each be substituted by one or two alkyl groups.

5. Liquid-crystalline medium according to claim 1, wherein the one or more compounds of the formula I comprise one or more compounds selected from the group of the compounds of formulae I-1 to I-42: 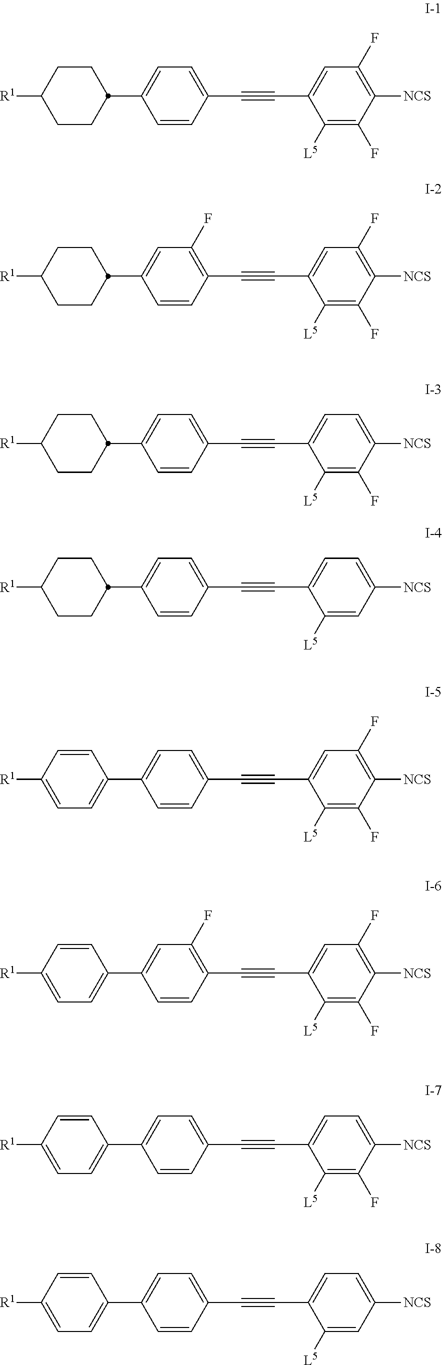 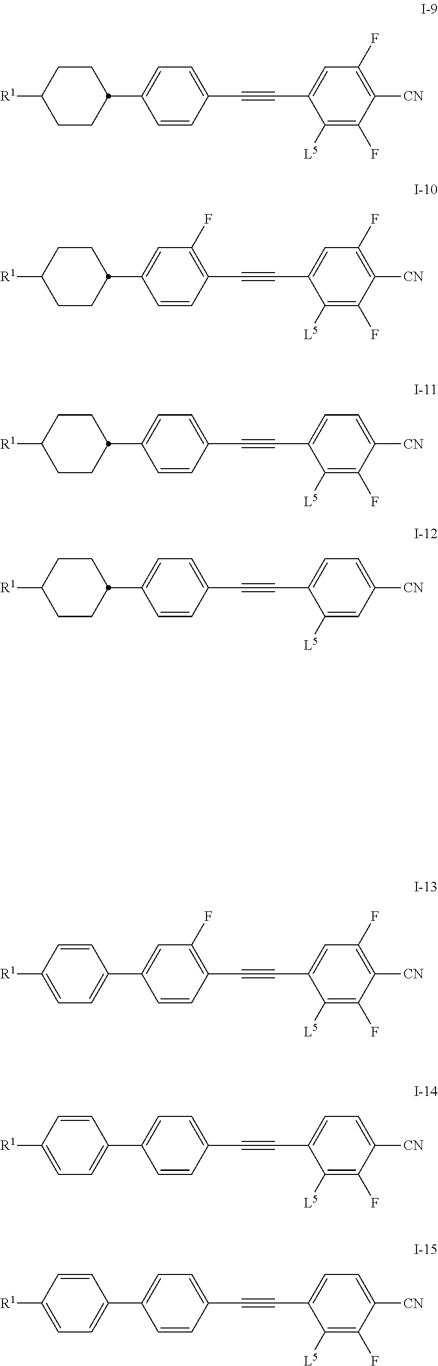 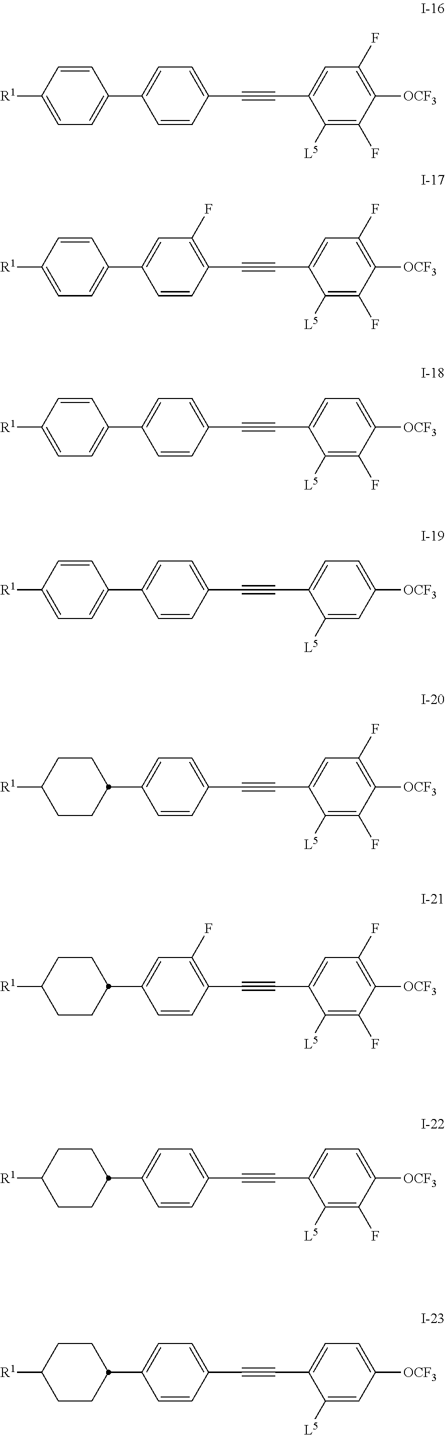 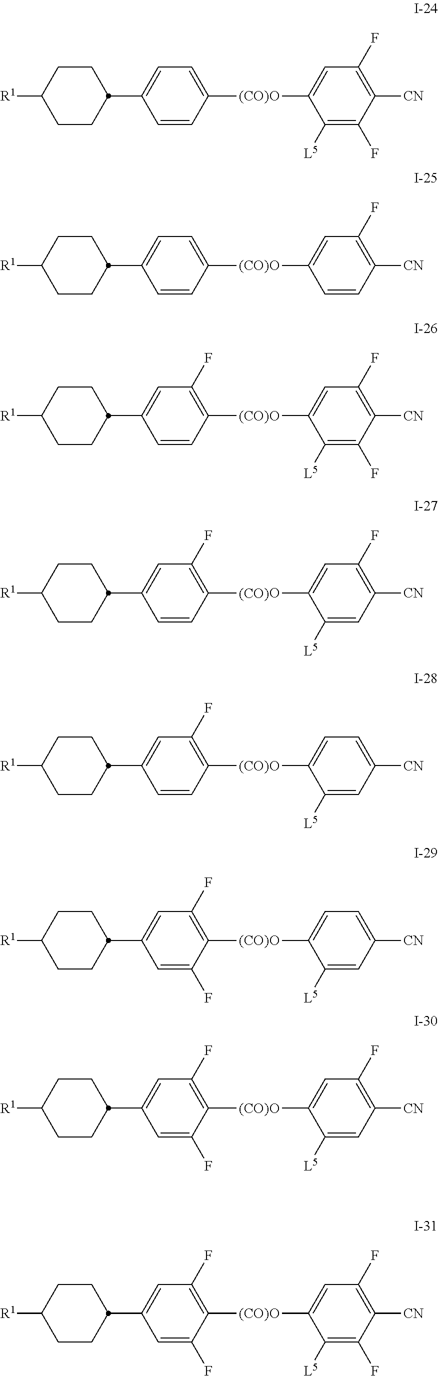 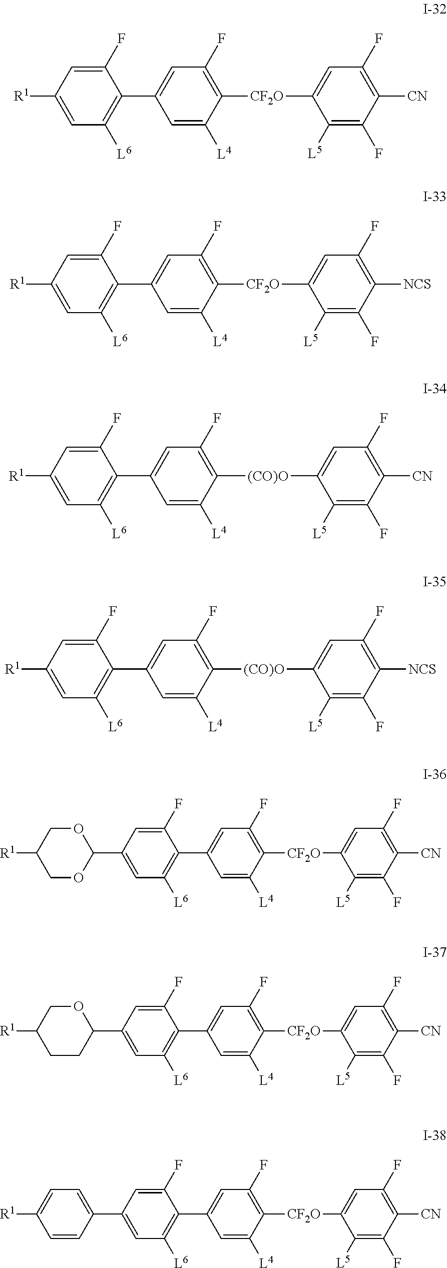 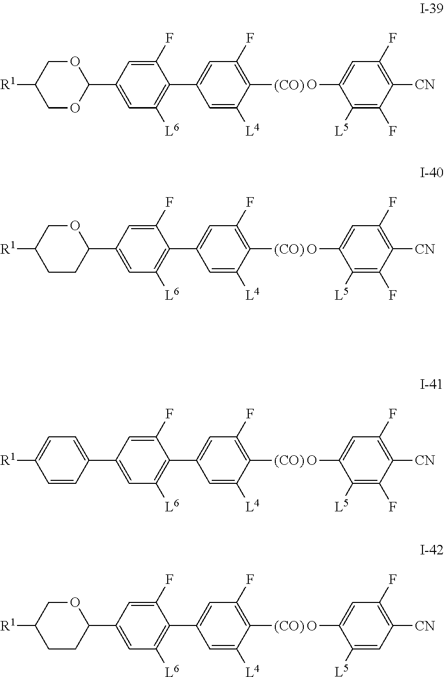
in which
R¹ is an alkyl radical having 1 to 15 C atoms, wherein one or more CH₂ groups, including terminal C atoms, in this radical may each be replaced, independently of one another, by —C≡C—, —CH═CH—, 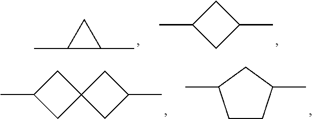
—O—, —S—, —(CO)—O—, —O—(CO)— in such a way that O or S atoms are not linked directly to one another, and in which, in addition one or more H atoms may be replaced by F or Cl, or H, and
L⁴ is F or H,
L⁵ is H, CH₃ or C₃H₇, and
L⁶ is F or H.

6. The liquid-crystalline medium according to claim 1, wherein
Z¹ is —C≡C— and
X¹ is CN or SCN.

7. The liquid-crystalline medium according to claim 1, comprising one or more compounds of the formulae VI, VII, VIII, or IX.

8. The liquid-crystalline medium according to claim 1, wherein the total concentration of the compounds of formula I in the medium as a whole is 10% to 35% by weight of the medium.

9. The liquid-crystalline medium according to claim 1, wherein compounds of the formula V comprise one or more compounds selected from structures V-7 and/or V-8: 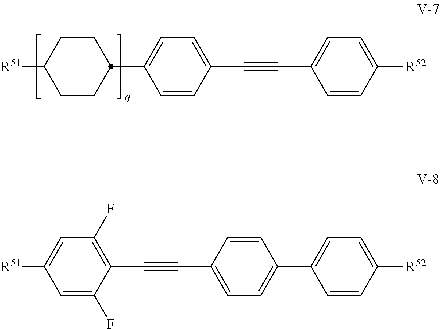
in which
q is 0 or 1
R⁵¹ denotes alkyl having 1 to 7 C atoms or alkenyl having 2 to 7 C atoms, and
R⁵² denotes alkyl having 1 to 7 C atoms, alkenyl having 2 to 7 C atoms or alkoxy having 1 to 6 C atoms.

10. An electro-optical lens or electro-optical display, comprising a liquid-crystalline medium according to claim 1.

11. An optical device comprising one or more electro-optical lenses according to claim 10, comprising a means to operate the lens by dual frequency addressing.

12. An electro-optical component comprising a medium according to claim 1 and having dual frequency addressing.

13. A process for the preparation of a liquid-crystalline medium according to claim 1, comprising mixing one or more compounds of formula I with one or more compounds selected from compounds of formulae II, III and VI to IX and optionally one or more additional mesogenic compounds and/or additives.
